(19) United States
(12) Patent Application Publication
(10) Pub. No.: US 2017/0257257 A1
(43) Pub. Date: Sep. 7, 2017

(54) COORDINATED CONTROL OF CONNECTED DEVICES IN A PREMISE

(71) Applicants: Paul DAWES, Redwood City, CA (US); Dana BURD, Redwood City, CA (US); Chris DECENZO, Redwood City, CA (US); Frank CHU, Redwood City, CA (US); Ren BITONIO, Redwood City, CA (US)

(72) Inventors: Paul DAWES, Redwood City, CA (US); Dana BURD, Redwood City, CA (US); Chris DECENZO, Redwood City, CA (US); Frank CHU, Redwood City, CA (US); Ren BITONIO, Redwood City, CA (US)

(21) Appl. No.: 15/292,866

(22) Filed: Oct. 13, 2016

Related U.S. Application Data
(63) Continuation-in-part of application No. 12/189,780, filed on Aug. 11, 2008, now abandoned.
Application No. 12/189,780 is a continuation-in-part of application No. 13/531,757, filed on Jun. 25, 2012.
Application No. 13/531,757 is a continuation-in-part of application No. 12/197,958, filed on Aug. 25, 2008.
Application No. 12/197,958 is a continuation-in-part of application No. 13/334,998, filed on Dec. 22, 2011, now Pat. No. 9,531,593.
Application No. 13/334,998 is a continuation-in-part of application No. 12/539,537, filed on Aug. 11, 2009.
Application No. 12/539,537 is a continuation-in-part of application No. 14/943,162, filed on Nov. 17, 2015.
Application No. 14/943,162 is a continuation-in-part of application No. 14/645,808, filed on Mar. 12, 2015.
Application No. 14/645,808 is a continuation-in-part of application No. 13/104,932, filed on May 10, 2011.
Application No. 13/104,932 is a continuation-in-part of application No. 13/104,936, filed on May 10, 2011.
Application No. 13/104,936 is a continuation-in-part of application No. 13/929,568, filed on Jun. 27, 2013.
Application No. 13/929,568 is a continuation-in-part of application No. 14/704,045, filed on May 5, 2015.
Application No. 14/704,045 is a continuation-in-part of application No. 14/704,098, filed on May 5, 2015.
Application No. 14/704,098 is a continuation-in-part of application No. 14/704,127, filed on May 5, 2015.
Application No. 14/704,127 is a continuation-in-part of application No. 14/628,651, filed on Feb. 23, 2015.
Application No. 14/628,651 is a continuation-in-part of application No. 13/718,851, filed on Dec. 18, 2012.
Application No. 13/718,851 is a continuation-in-part of application No. 13/954,553, filed on Jul. 30, 2013.
Application No. 13/954,553 is a continuation-in-part of application No. 15/177,915, filed on Jun. 9, 2016.
Application No. 15/177,915 is a continuation-in-part of application No. 15/177,448, filed on Jun. 9, 2016.
Application No. 15/177,448 is a continuation-in-part of application No. 15/196,281, filed on Jun. 29, 2016.
Application No. 15/196,281 is a continuation-in-part of application No. 15/198,531, filed on Jun. 30, 2016.
(60) Provisional application No. 62/240,584, filed on Oct. 13, 2015.

(51) Int. Cl. H04L 12/24; H04L 29/06

(52) U.S. Cl. CPC H04L 41/06; H04L 69/18

(57) ABSTRACT

A system comprises a bridge server configured to exchange event data and control data with premises devices. An application server coupled to the bridge server is configured to exchange the event data and the control data with the bridge server. The application server includes virtual devices comprising logical models corresponding to the premises devices and configured to use the event data and the control data to maintain state of the premises devices. The application server includes a rules engine configured to control interaction among the premises devices. An application engine coupled to the application server communicates with a device application configured for execution when installed on a remote device. The device application generates a user interface configured to present the event data and state of the premises devices and receive as input the control data of the premises devices.

### RELATED APPLICATIONS

This application claims the benefit of United States (U.S.) Patent Application No. 62/240,584, filed Oct. 13, 2015.

This application is a continuation in part application of U.S. patent application Ser. No. 12/189,780, filed Aug. 11, 2008.

This application is a continuation in part application of U.S. patent application Ser. No. 13/531,757, filed Jun. 25, 2012.

This application is a continuation in part application of U.S. patent application Ser. No. 12/197,958, filed Aug. 25, 2008.

This application is a continuation in part application of U.S. patent application Ser. No. 13/334,998, filed Dec. 22, 2011.

This application is a continuation in part application of U.S. patent application Ser. No. 12/539,537, filed Aug. 11, 2009.

This application is a continuation in part application of U.S. patent application Ser. No. 14/943,162, filed Nov. 17, 2015.

This application is a continuation in part application of U.S. patent application Ser. No. 14/645,808, filed Mar. 12, 2015.

This application is a continuation in part application of U.S. patent application Ser. No. 13/104,932, filed May 10, 2011.

This application is a continuation in part application of U.S. patent application Ser. No. 13/104,936, filed May 10, 2011.

This application is a continuation in part application of U.S. patent application Ser. No. 13/929,568, filed Jun. 27, 2013.

This application is a continuation in part application of U.S. patent application Ser. No. 14/704,045, filed May 5, 2015.

This application is a continuation in part application of U.S. patent application Ser. No. 14/704,098, filed May 5, 2015.

This application is a continuation in part application of U.S. patent application Ser. No. 14/704,127, filed May 5, 2015.

This application is a continuation in part application of U.S. patent application Ser. No. 14/628,651, filed Feb. 23, 2015.

This application is a continuation in part application of U.S. patent application Ser. No. 13/718,851, filed Dec. 18, 2012.

This application is a continuation in part application of U.S. patent application Ser. No. 13/954,553, filed Jul. 30, 2013.

This application is a continuation in part application of U.S. patent application Ser. No. 15/177,915, filed Jun. 9, 2016.

This application is a continuation in part application of U.S. patent application Ser. No. 15/177,448, filed Jun. 9, 2016.

This application is a continuation in part application of U.S. patent application Ser. No. 15/196,281, filed Jun. 29, 2016.

This application is a continuation in part application of U.S. patent application Ser. No. 15/198,531, filed Jun. 30, 2016.

### BACKGROUND

There exists a need for systems, devices, and methods that interface Connected Devices and media management to existing proprietary technologies and allow control of the Connected Devices and the existing proprietary technologies, for example security technologies, without requiring extensive modifications to the ‘in situ’ system (e.g., security system, etc.).

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of a connected device system configured to include devices (e.g., smart devices, connected devices, security devices, etc.) at a premises in communication with a server environment, under an embodiment.

FIG. 2 is a block diagram of a connected device system showing components of the connected device gateway at the premises and the session server in the cloud-based server environment, under an embodiment.

FIG. 3 is a block diagram of an example connected device system including a bridge server, under an embodiment.

FIG. 4 is a block diagram of a system comprising a bridge server in communication with devices and an application server and gateway server, under an embodiment.

FIG. 5 is an example connected device flow diagram, under an embodiment.

FIG. 6 is another example connected device flow diagram, under an embodiment.

FIG. 7 is yet another example connected device flow diagram, under an embodiment.

FIG. 8 is a block diagram of a system including the Cloud Hub, under an embodiment.

FIG. 9 is a block diagram of a system including a Cloud Hub and Virtual Gateway showing the premises, service provider, and mobile environments, under an embodiment.

FIG. 10 is a flow diagram for device installation and bootstrapping, under an embodiment.

FIG. 11 is a block diagram of the LWGW class structure, under an embodiment.

FIG. 12 is a block diagram of the integrated security system, under an embodiment.

FIG. 13 is a block diagram of components of the integrated security system 100, under an embodiment.

FIG. 14 is a block diagram of the gateway 102 including gateway software or applications, under an embodiment.

FIG. 15 is a block diagram of components of the gateway 102, under an embodiment.

### DETAILED DESCRIPTION

The present invention relates generally to methods and systems for enabling devices at a premises or across premises to interact with each other and with a WAN to provide an integrated home automation and security solution. More particularly, it relates to a method and apparatus for utilizing one or more of Internet Protocol (IP) and other Home Area Networking (HAN) protocols (e.g., Bluetooth, Z-Wave, Zigbee, etc.) for interfacing to and controlling devices and security systems from within a home or business, and extending such control and interface to remote devices outside the premise.

A system comprises a bridge server configured to exchange event data and control data with premises devices. An application server coupled to the bridge server is configured to exchange the event data and the control data with the bridge server. The application server includes virtual devices comprising logical models corresponding to the premises devices and configured to use the event data and the control data to maintain state of the premises devices. The application server includes a rules engine configured to control interaction among the premises devices. An application engine coupled to the application server communicates with a device application configured for execution when installed on a remote device. The device application generates a user interface configured to present the event data and state of the premises devices and receive as input the control data of the premises devices.

Although this detailed description contains many specifics for the purposes of illustration, anyone of ordinary skill in the art will appreciate that many variations and alterations to the following details are within the scope of the invention. Thus, the following illustrative embodiments of the invention are set forth without any loss of generality to, and without imposing limitations upon, the claimed invention. Note that whenever the same reference numeral is repeated with respect to different figures, it refers to the corresponding structure in each such figure.

The ‘Internet of Things’ (IOT) and ‘Connected Home’ are terms used to describe the growth of devices within a premises that include some form of local intelligence, connectivity to other devices, or connectivity to ‘cloud-based services’ located remotely from the premises. Some examples of devices included within the existing art include connected or ‘smart’ thermostats, cameras, door locks, lighting control solutions, security sensors and controllers, HVAC controllers, kitchen appliances, etc.

In the conventional art these devices typically include an IP protocol connection to a server remote to the premise Cin the cloud'). This server often provides remote access and control of the device through mobile apps running on phones or tablets. In some cases the connected devices communicate through this ‘cloud’ server to other devices through their own servers ‘in the cloud’. By way of example, a thermostat in a home can connect to a corresponding cloud server and relay state information to the cloud service of a connected light switch at the same premises. In this way a state change in one device can trigger actions in other devices using the ‘cloud relay’ mechanism. Further, high bandwidth media applications (e.g., video, voice, etc.) use complex and proprietary approaches or protocols to provide remote access including such processes as router port-forwarding and/or heavy-weight server proxies and protocols.

In contrast, the field of home and small business security is served by technology suppliers providing comprehensive ‘closed’ security systems in which individual components (e.g., sensors, security panels, keypads, etc.) operate exclusively within the confines of a single-vendor or proprietary solution. For example, a wireless motion sensor provided by vendor A cannot be used with a security panel provided by vendor B. Each vendor typically has developed sophisticated proprietary wireless technologies to enable the installation and management of wireless sensors, with little or no ability for the wireless devices to operate separate from the vendor's homogeneous system. Furthermore, these ‘closed’ systems are extremely proprietary in their approach to interfacing with either local or wide area standards-based network technologies (e.g., IP networks, etc.). Wireless security technology from providers such as GE Security, Honeywell, and DSC/Tyco are well known in the art, and are examples of this proprietary approach to security systems for home and business.

There is inherent difficulty under this ‘closed system’ approach in interfacing between the plethora of ‘Connected Home’ devices and the proprietary home security systems. Home security system vendors use proprietary LAN protocols and proprietary cloud services to manage and interact with security devices in the home. There is no way for a ‘cloud connected device’ to easily integrate with a security system from any of the proprietary system vendors. Further, it is difficult if not impossible to integrate media into such a proprietary system.

Integration involving a closed system is also difficult due to the complexity and cost of the physical interface between the proprietary security system and the more open ‘Connected Home’ devices. Because the systems are proprietary, typically additional hardware must be retrofitted to these security systems to enable them to communicate locally with non-proprietary devices. This hardware often requires additional wiring or the incorporation of new wireless technologies (e.g., Wifi, Zigbee, etc.) that must be retrofitted to the extant proprietary security system.

Installation and operational complexities also arise due to functional limitations associated with hardwiring a new component into existing security systems. Further, and no less difficult, is interfacing of a new component(s) with the existing system using RF/wireless technology, because installation, security, and the requirement of new radios in the security system impart additional complexity.

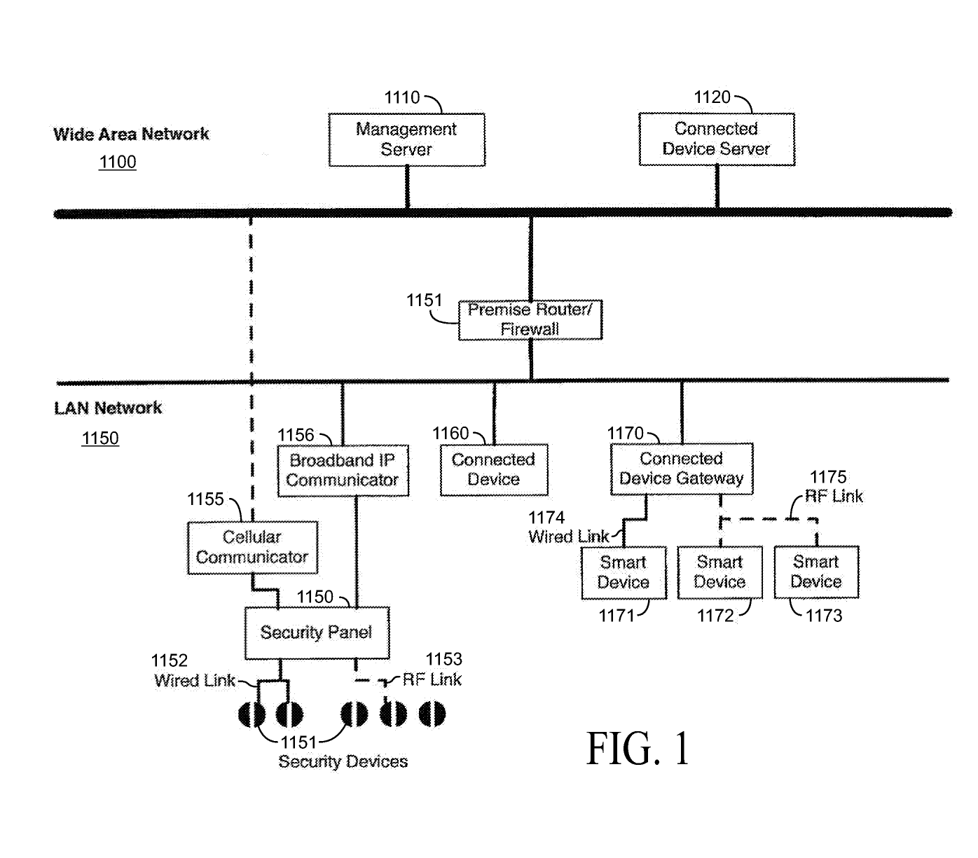

FIG. 1 is a block diagram of a connected device system configured to include devices (e.g., smart devices, connected devices, security devices, etc.) at a premises in communication with a server environment, under an embodiment. The system includes a connected device gateway 1170 at the premises coupled or connected to one or more smart devices 1171-1173 at the premises via wired 1174 and/or wireless channels or protocols 1175. The system also includes one or more independent connected devices 1160 that are independent of any gateway. The independent connected devices 1160 of an embodiment are coupled or connected to a premises local area network (LAN) 1150 but are not so limited. A security panel 1150 of a premises security system is coupled to the server environment via a coupling or connection to a wide area network (WAN) 1100; the coupling to the WAN 1100 comprises a coupling or connection to a broadband IP communicator 1156 that is coupled to the LAN 1150 and/or a coupling or connection using a cellular communicator and a cellular or other wireless radio channel 1155. The security system includes security devices 1151 at the premises coupled or connected to the security panel 1150 via wired 1152 and/or wireless channels or protocols 1153.

The server environment of the connected device system includes one or more of a bridge server, connected device server, and security server, as described in detail herein. Each smart device coupled to the connected device gateway at the premises has a corresponding connected device server but the embodiment is not so limited. Thus, connected device configurations of an embodiment include configurations in which a connected device server is dedicated to each smart device, a connected device server is dedicated to a type of smart device (e.g., first connected device server for sensor devices, second connected device server for automation devices, etc.), a connected device server is dedicated to a type of protocol used by the smart devices (e.g., first connected device server for Z-Wave devices, second connected device server for Zigbee devices, etc.), and/or a connected device server is dedicated to a plurality of smart devices. The connected device server of an embodiment is configured as one or more of a router that routes or directs communications to/from one or more corresponding connected or smart devices, a service provider (e.g., server in the middle) that stores at least a portion of data of smart or connected devices, and a gateway that couples remote devices (e.g., smart phones, tablet computers, personal computers, etc.) to the connected or smart devices. Applications hosted or running on client devices (e.g., remote devices, iOS devices, Android devices, web browsers, etc.) are configured to communicate with the connected devices, smart devices, connected device gateway, and/or security system (panel) at the premises through their respective servers. In this manner, the system of an embodiment is configured to provide control of and access to data of a variety of smart and connected devices at the premises using the client device application synchronized to the smart or connected devices via the cloud-based server environment.

The system of an embodiment generally includes one or more of a cellular radio or broadband ‘IP communicator’ module that is included as a component of or coupled to the proprietary security system. These communicators have typically served to communicate critical life-safety and intrusion signals to a remote central monitoring station, or to provide remote control of the security system from personal computers, mobile devices, and/or other remote client devices to name a few. The communicators of an embodiment (e.g., whether cellular or broadband-based) are each configured to provide a linkage between the security system and the ‘Connected Home’ devices through a cloud server-to-server interface.

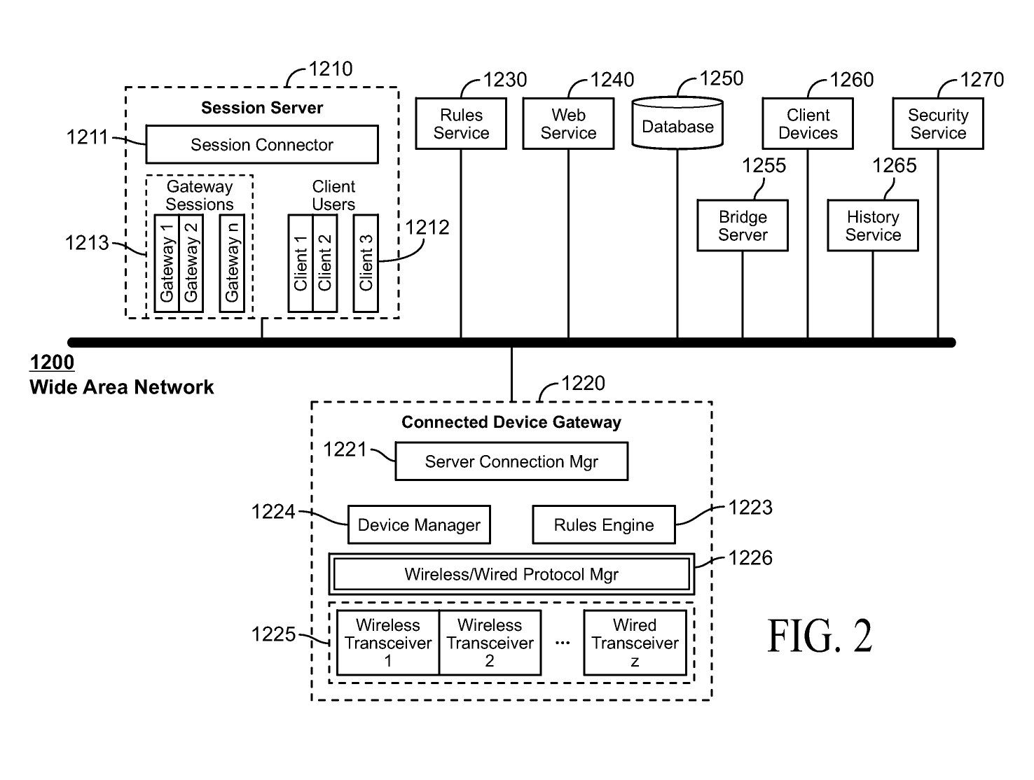

FIG. 2 is a block diagram of a connected device system showing components of the connected device gateway at the premises and the session server in the cloud-based server environment, under an embodiment. The connected device gateway 1220, which is also referred to herein as “Cloud Hub” in some embodiments, comprises a processor that includes or is coupled to one or more logical components that include a server connection manager 1221, a device manager 1224, a rules engine 1223, and a communication protocol manager 1226 (e.g., wired, wireless, etc.). The communication protocol manager 1226 is coupled to the transceivers 1225 or radios of the connected device gateway 1220 that are configured to communicate with the various connected devices at the premises. The server connection manager 1221 is configured to communicate with servers coupled to the WAN, while the device manager is configured to manage communications with devices at the premises.

The system of an embodiment also includes a security panel of a security system coupled to a wide area network (WAN) via a coupling or connection to a broadband IP and/or a cellular communicator (not shown), as described with reference to FIG. 1. Applications hosted or running on client devices (e.g., remote devices, iOS devices, Android devices, web browsers, etc.) are configured to communicate with the connected devices, smart devices, connected device gateway, and/or security system (panel) at the premises through their respective servers.

The server or cloud environment of an embodiment comprises one or more logical components that include a rules service 1230, web service 1240, client devices service 1260, history service 1265, and security service 1270, to name a few. The rules service 1230 (e.g., IFTT, etc.) is configured to generate rules for the rules engine 1223, where the new rules complement and/or replace rules hosted or running in the rules engine. The web service 1240 is configured to manage web portal communications. The client devices service 1260 is configured to manage communications of client device applications. The history service 1265 is configured to manage history data associated with components of the system (e.g., client devices, connected devices, gateways, sessions, etc.). The security service 1270 is configured to manage communications and/or data of a security panel (system) at the premises that is a component of the cloud system described in detail herein.

The connected device gateway 1220 communicates with a session server 1210 (cloud router) that comprises gateway sessions 1213, also referred to in embodiments as “Lightweight Gateway (LWGW) instances.” The session server 1210 with the gateway sessions 1213 is configured to manage communications with gateways, client devices, etc. The session server 1210 is configured as a communication relay or router (e.g. cloud router) that relays communications between devices; alternatively, the session server 1210 is configured to provide a device initiating a communication session with an address (e.g., IP address, etc.) of the target device so that the initiating device and the target device communicate directly without going through the session server. As such, the session server 1210 is configured to manage couplings or connections between the communicator module or device and the cloud server.

The server environment of an embodiment also includes a bridge server 1255 configured to provide an open communications interface between the smart devices and/or the connected devices and the security system. Any device can be a plugin or a subscriber to the bridge server, but the embodiment is not so limited.

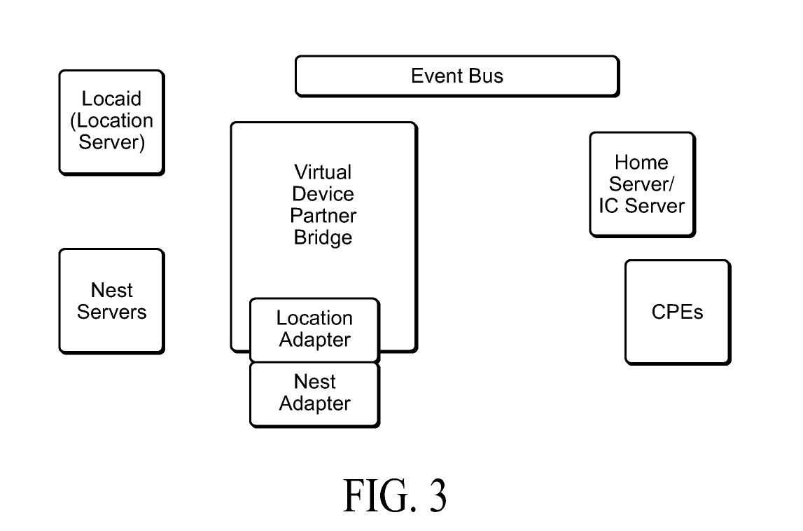

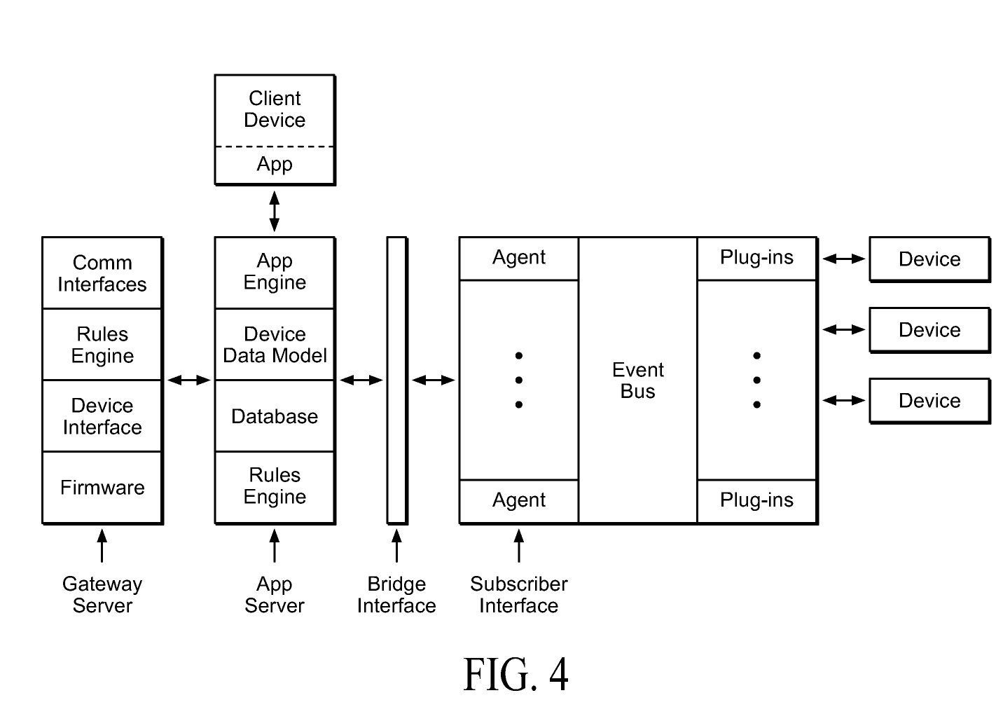

FIG. 3 is a block diagram of an example connected device system including a bridge server, under an embodiment. FIG. 4 is a block diagram of a system comprising a bridge server in communication with devices and an application server and gateway server, under an embodiment. With reference to these figures, the bridge server includes an event bus (e.g., bidirectional event bus) coupled to a set of device-specific plugins (e.g., location adapter, Nest adapter, etc.) that each corresponds to a particular device or type of device. Each plugin comprises code written to an API that corresponds to that device. Each plugin puts events for its corresponding device onto the event bus (e.g., Nest thermostat, change temperature, etc.) and receives data via the event bus. The plugins of an embodiment include but are not limited to an API plugin, a UI plugin, and a card UI.

The bridge server includes a subscriber interface coupled to the event bus, and the subscriber interface comprises one or more user agents or agents. The agent(s) of the subscriber interface pulls events or event data from the event bus and transfers them to another component or application as described herein. The subscriber interface also puts events onto the event bus for transfer to the device-specific plugins.

The subscriber interface is coupled to an application (“app”) server (e.g., Location server, Nest servers, etc.) via a bridge interface. The app server includes one or more components that comprise one or more of an app engine, a rules engine, a device data model, and a database. The app engine serves events to a corresponding app and/or receives data from the corresponding app. The rules engine includes rules that are executed in response to event data. The device data model, also referred to as a virtual device, is a device data definition or logical model. The database stores records that include event data and corresponding data or information. The components of the app server communicate with a gateway server that manages components (e.g., firmware, devices, rules engine, communication interface(s), etc.) of a gateway at the premises.

As an example, a user has a Nest thermostat in her home, and when the temperature changes at the thermostat then the thermostat puts an event on the event bus indicating the temperature change. The event includes a unique identifier of the thermostat, and a user agent of the bridge server is listening for the identifier. The user agent, when it identifies an event having an identifier for which it is listening, pulls the event with the particular identifier from the event bus. Data of the event when pulled from the event bus can, for example, be stored in a database, and also checked for correlation to any rule running under the rules engine and, if a correlation is identified, then the data causes the rule to execute.

The rules engine is configured to enable end users or system providers to establish linkages between information or data of device state changes (‘triggers’) and the control of other devices (‘actions’). The rules engine is configured, for example, to control the state of a smart (connected) device (e.g. a thermostat or door lock) in response to a state change of a corresponding connected system (e.g., the security system). As another example, the rules engine controls the state of the security system (e.g., disarm security system (‘action’)) in response to a state change in a connected device (e.g., unlocking of a door (‘trigger’)). The rules engine also controls the state of a LAN device (e.g., a Z-Wave thermostat) by determining a state change of the security system and relaying the desired Connected Device state to the intermediate Cloud Hub for processing.

The rules engine of an embodiment runs or executes at least one of remotely on a cloud-based server (e.g., Rules Service, etc.), locally on consumer premises equipment (CPE) or a premises device (e.g., the Cloud Hub, etc.), and in some distributed combination of devices of the system. The rules engine is configured to store and run at least a portion of the rules locally at the premises in the Cloud Hub or other local CPE. The rules engine of an alternative embodiment is configured to store the rules in a remote server that is located remote to the premises in the server or cloud environment. The rules engine of another alternative embodiment is configured to distribute storage and execution of the rules between local CPE and remote server(s) for redundancy or to provide more timely operation.

The premises devices and systems operate according to rules running on a rules engine at the premises (CPE) and/or in the cloud. Generally, a system configuration includes rules executed on a server in the cloud to support interactions between two or more premises devices (e.g., an event of a first device triggers an action on a second device via one or more rules, etc.). Furthermore, a system configuration includes rules running locally at the premises (e.g., CPE) to support interactions with other devices at the premises via direct interactions when information is not required from a third party or remote server or system in order to effect the interaction.

Additionally, rules running locally at the premises (e.g., CPE) and at a cloud-based server control interaction under an embodiment. For example, a door opens at the premises causing a sensor signal to be sent to the security panel, and the security panel in turn provides notification of the sensor event to a gateway. Rule(s) running at the gateway cause the gateway to issue a request to a cloud-based server for an action by a particular connected device (e.g., camera device at the premises, camera device at a different premises, etc.). Rule(s) running at the server generate a command or control signal to perform the action and send the command to the particular connected device. The particular connected device includes, for example, another device at the premises (e.g. camera in the premises, etc.) and/or a device at a difference premises (e.g., initiate an alarm at a first house if a door is opened at a second house). Optionally, an acknowledgement is generated or issued by the connected device upon completion of the requested action.

The system described herein provides a cloud interface to connected premises (e.g., home, office, etc.) devices and systems. For example, a system includes one or more on-premise devices coupled to a premises security system, and a smart device (e.g., Nest thermostat, etc.) is integrated at the premises through the cloud to the premises system that includes the premises devices and security system.

As a more particular example, the premises includes a security panel and security devices communicating with the cloud (“server environment”) via a broadband IP module, cellular communicator, and/or a gateway. The premises includes a second device (e.g., Z-Wave controller, etc.) that provides or creates a local device network (e.g., Z-Wave, Zigbee, WiFi, WPS, etc.) coupled or connected to the premises LAN. The premises of this example includes a third device (e.g., one or more Dropcams, etc.) comprising a WiFi client communicating with the cloud. Under the configurations described herein, two or more premises devices are coupled at the premises via a connected device gateway and/or at the cloud via a server interface, but are not so limited. Each of the premises devices (e.g., smart devices, connected devices, security devices, etc.), regardless of device type or protocol, is integrated into the system through pushbutton enrollment.

The system of an alternative embodiment includes a gateway device located at the premises. The gateway device is configured to provide a plurality of network interfaces that include, but are not limited to, one or more LAN interfaces for communicating with devices within the premise (e.g., Z-Wave, Wifi, Zigbee, etc.), and a WAN interface for communicating with the Session Server. In this ‘Cloud Hub’ embodiment the gateway is not required to provide a local area coupling or connection between the Connected Home devices and the security system because this connection is provided by/through the cloud interface.

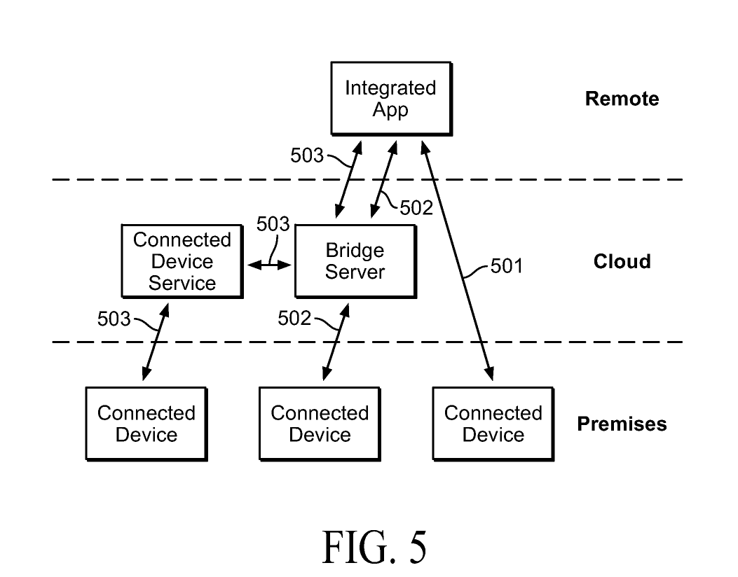

The embodiments of the connected premises systems described herein include numerous operational flows, but are not so limited. FIG. 5 is an example connected device flow diagram, under an embodiment. This example includes three connected devices (e.g., thermostat, camera, smart lock), each of which corresponds to a third party server and control application for accessing and controlling the respective device. In addition to the three connected devices in the premises, the system of this example includes a cloud-based connected device server and bridge server, and an integrated or combined device application hosted on a remote client device. The integrated device application is configured to provide integrated access to the three connected devices but is not so limited. The bridge server is configured to aggregate (e.g., using APIs) interfaces to the three third party servers of the device providers and enables communication between the bridge server and these third party servers. The bridge server is configured to communicate directly with one or more of the connected devices and to communicate with the connected devices through the connected device server.

The combined device application provided in an embodiment is an application hosted on a client device (e.g., downloaded to the client device, installed on the client device, etc.) that includes the capabilities of the individual control applications of the respective connected devices. In an embodiment, the combined application is configured to communicate 501 directly with the corresponding connected device(s) (e.g., using information from the bridge server and/or connected device server). In an alternative embodiment, the combined application is configured to communicate 502 with the corresponding device(s) through the bridge server, which communicates with the third party server corresponding to the respective device(s). In another alternative embodiment, the combined application is configured to communicate 503 with the corresponding connected device(s) through the bridge server and the connected device server.

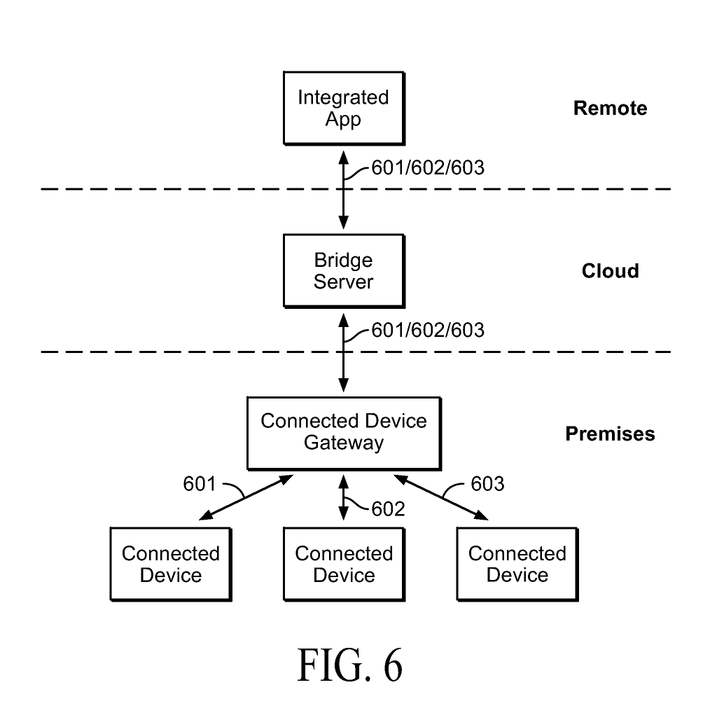

FIG. 6 is another example connected device flow diagram, under an embodiment. This example includes three connected devices (e.g., thermostat, camera, smart lock), each of which corresponds to a third party server and control application for accessing and controlling the respective device. The three connected devices are coupled to a connected device gateway in the premises as described in detail herein. In addition to the three connected devices in the premises, the system of this example includes a cloud-based bridge server. The bridge server is configured to aggregate (e.g., using APIs) interfaces to the three third party servers of the device providers and enables communication between the bridge server and these third party servers. The bridge server is configured to communicate with the connected devices through the connected device server.

The system of this example includes an integrated or combined device application hosted on a remote client device to provide integrated access to the three connected devices. In an embodiment, the combined application communicates 601/602/603 with the corresponding device(s) through the bridge server, which communicates 601/602/603 directly with the connected device gateway at the premises. Additionally, the connected device gateway is configured to synchronize between connected devices at the local premises and connected devices at a remote premises.

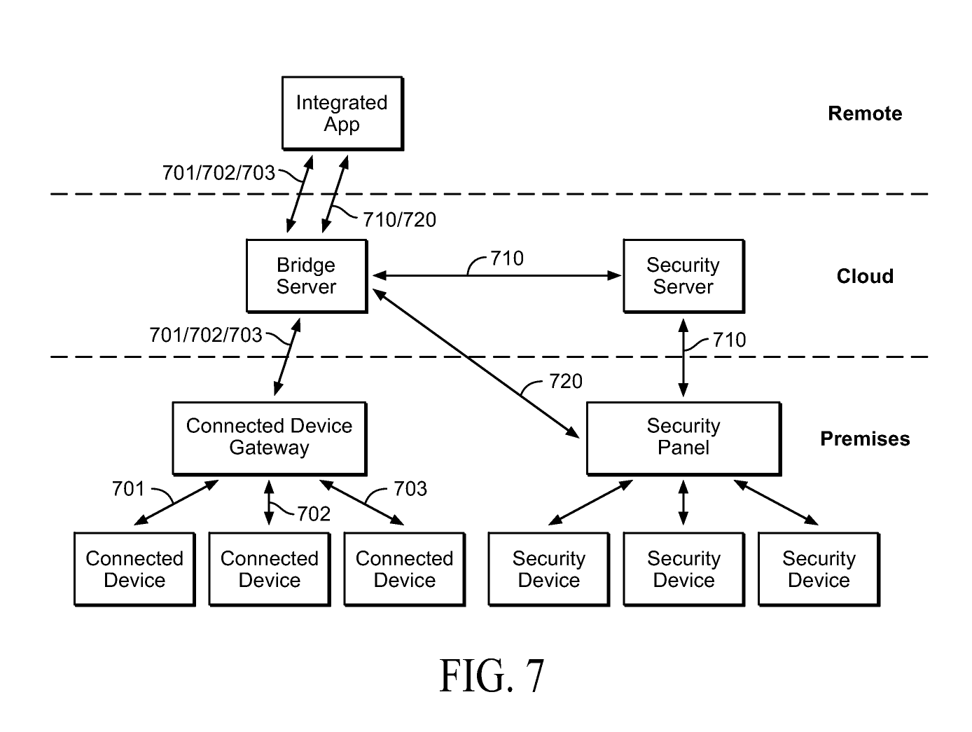

FIG. 7 is yet another example connected device flow diagram, under an embodiment. This example includes three connected devices (e.g., thermostat, camera, smart lock), each of which corresponds to a third party server and control application for accessing and controlling the respective device. The three connected devices are coupled to a connected device gateway in the premises as described in detail herein. In addition to the three connected devices in the premises, the system of this example includes a cloud-based bridge server. The bridge server is configured to aggregate (e.g., using APIs) interfaces to the three third party servers of the device providers and enables communication between the bridge server and these third party servers. The bridge server is configured to communicate with the connected devices through the connected device server.

The system of this example also includes three security devices (e.g., door sensor, window sensor, motion detector) coupled to a security panel at the premises. The local security panel communicates with a cloud-based security server. The bridge server of an embodiment communicates with the security panel via the security server. Alternatively, the bridge server communicates directly with the security panel as it does with the connected device gateway, and integrates the interfaces of the connected device providers and the security system provider, but is not so limited.

The system of this example includes an integrated or combined device application hosted on a remote client device and configured to provide integrated access to the three connected devices and the security panel. In an embodiment, the combined application communicates 701/702/703 with the connected device(s) via the bridge server and the connected device gateway at the premises, and communicates 710 with the security devices via the bridge server, the security server, and the security panel. Alternatively, the combined application communicates 720 with the security devices via the bridge server and the security panel.

The connected device gateway is configured to synchronize between connected devices at the local premises and connected devices at a remote premises. Similarly, the security panel is configured to synchronize between security devices at the local premises and security devices at a remote premises.

A process flow of an embodiment for interaction between the integrated app and a connected device comprises but is not limited to the following: an event is commanded at the app for a connected device (e.g., temperature increase commanded three increments); the event is posted to the device data model at the app server; the device data model posts data representing the event on the bridge interface of the bridge server; the bridge interface posts data representing the event onto the event bus; the connected device (e.g., thermostat) plugin, which is listening for events that correspond to the device, pulls the event data from event bus and passes the event (command) data to the corresponding connected device; the event (command) data causes a corresponding change at the connected device (e.g., temperature raised three degrees on thermostat).

A process flow of an embodiment for interactions among connected devices resulting from a state change at a connected device comprises but is not limited to the following: an event is detected at a connected device (e.g., temperature rises 5 degrees to 72 degrees); the device puts data of the event on the event bus of the bridge server via the corresponding device plugin; an agent or listener subscribed to the connected device pulls data of the event from event bus and transfers the data to the app server; app engine of app server posts the event to the corresponding app, and posts the event data in the database; app engine posts the event data to the rules engine because the rules engine, which includes a rule that corresponds to the event (e.g., if temperature rises above 70 degrees, turn on lamp in den); rules engine executes the rule and sends a message to the gateway server to carry out the action (e.g., turn on lamp in den) or, alternatively, the rules engine passes the event data to the gateway server, which executes the rule for the connected device (lamp).

A process flow of an embodiment for interactions among connected devices resulting from a state change at a security sensor comprises but is not limited to the following: an event is detected at a sensor; sensor event data received from the sensor and processed at the security panel; the processed sensor event data is transmitted to the security server where it is stored; the security server posts information representing the sensor event data via an API; the security server communicates the sensor event to the bridge server via a security system plugin; an agent or listener subscribed to the security system pulls data of the event from the event bus and transfers the data to the app server via the bridge interface; app engine of app server posts the event to the corresponding app, and posts the event data in the database; app engine posts the event data to the rules engine because the rules engine, which includes a rule that corresponds to the event (e.g., if door sensor state change, record video at door camera); rules engine executes the rule and sends a message to the gateway server to carry out the action (e.g., activate door camera) or, alternatively, the rules engine passes the event data to the gateway server, which executes the rule for the connected device (camera).

Embodiments include pushbutton enrollment of devices (e.g., smart devices, connected devices, security devices, etc.) into the premises environment using one or more technologies. In an embodiment, the device is triggered to initiate an enrollment routine or process that enrolls the smart device into the premises environment via one or more of the premises components described herein (e.g. connected devices, smart devices, gateways, security devices, etc.). Device enrollment causes the enrolling device to update the system as to the state of currently installed devices via the coupling to the sever environment. When a device is added to the system, the system automatically recognizes the device in the system and populates the device throughout the system. Similarly, when a device is removed from the system, the system removes the device throughout the system.

More particularly, a process flow of an embodiment for enrolling and accessing connected or smart devices comprises but is not limited to the following: bridge server identifies supported device(s); bridge server locates supported device(s) on local network or prompts user for added device(s); bridge server authenticates or validates device(s); validated device(s) is added to the integrated or combined app for control and/or rules; generic device-specific interface is presented to user (e.g., generic thermostat interface), and/or customized device-specific interface is presented to user, and/or launch third party UI for device.

A process flow of an alternative embodiment for enrolling and accessing connected or smart devices comprises but is not limited to the following: bridge server identifies supported device(s); identified device(s) added to the system; added device(s) connects to connected device server and corresponding connected device app; integrated app is downloaded, downloaded app identifies devices to be bridged (keys, login credentials) and authenticates or validates device(s); validated device(s) is added to the app for control and/or rules; generic device-specific interface is presented to user (e.g., generic thermostat interface), and/or customized device-specific interface is presented to user, and/or launch third party UI for device.

The embodiments described in detail herein provide the Cloud Hub as a low-cost solution for home automation, which can be added to an existing site (e.g., Tier-1 site). The Cloud Hub device of the embodiments, as a component of the consumer premises equipment (CPE), couples or connects to a broadband connection at the host premises and is configured as a gateway for devices (e.g., cameras, sensors, Z-Wave, Zigbee, etc.) located or installed at the premises. More particularly, the Cloud Hub is a multi-purpose device access point configured to enable full home automation. The Cloud Hub is configured to enable premises devices (e.g., cameras, sensors, Z-Wave, Zigbee, etc.) for sites that do not currently support these devices, and/or provide a “sandbox” for Direct Cameras, but is not so limited.

The Cloud Hub of an embodiment is configured to communicate with a Lightweight Gateway (LWGW) that includes a corresponding server-side abstraction with which it interacts or communicates. In an embodiment this device class interacts with the server and the actual Cloud Hub device in much the same way that a RISSecurityPanel class interacts, as described in detail herein. As such, an embodiment re-factors the common code out of the RISSecurityPanel into a class capable of use by both the RISSecurityPanel and the Cloud Hub device. A new device definition is provided for this type of device, along with various changes to the StandardGateway class to control and manage the additional communication channel with the new device.

The Session Server of an embodiment is configured to use a gateway registry service to route incoming UDP packets from the CPE to the proper LWGW instance via a one to one mapping of CPE-unique IDs to site IDs. With the addition of the Cloud Hub, a second CPE-unique ID is used which is mapped to the same LWGW instance as the primary SMA client's CPE-unique ID. To accomplish this the Device Registry service is leveraged, and this registry maintains a mapping of CPE ID and device type to site ID. The session server is configured to use this Device Registry to properly route income packets but is not so limited.

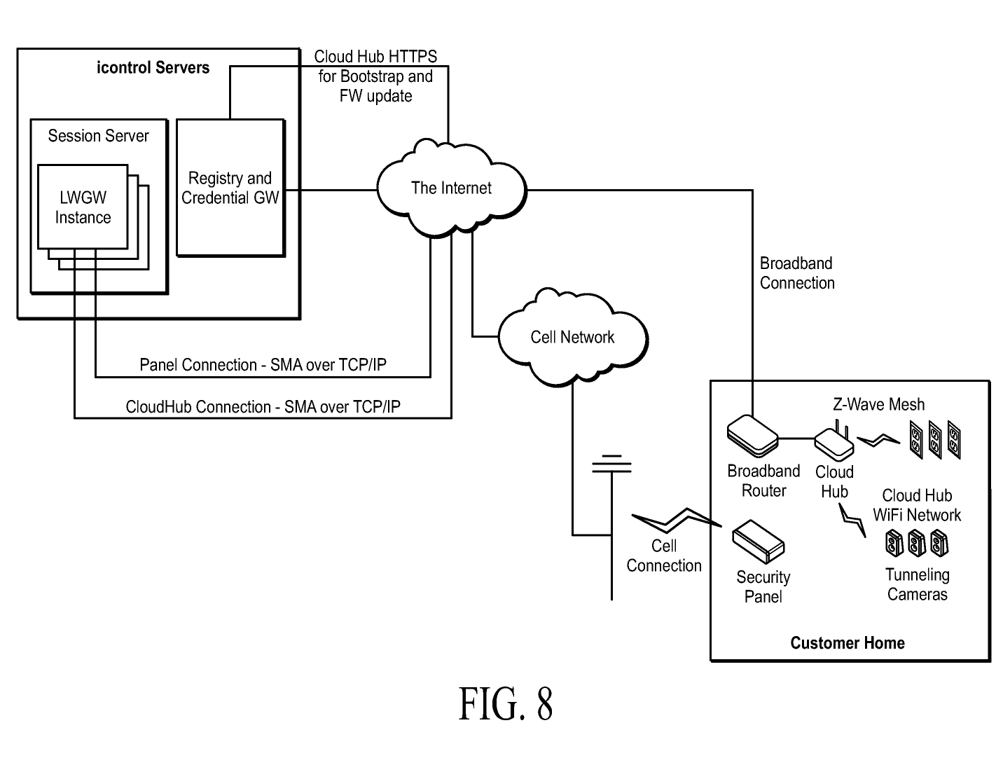

FIG. 8 is a block diagram of a system including the Cloud Hub, under an embodiment. The system configuration includes a Cloud Hub coupled to a wide area network (WAN) at the premises. The iControl servers include a session server and one or more LWGW instances, and a registry and credential gateway, as described in detail herein. The device installation and bootstrap mechanism is configured to one or more of associate the Cloud Hub device with an existing site, and securely deliver SMA communication configuration, including master key, SMA server address, and network ports, but is not so limited.

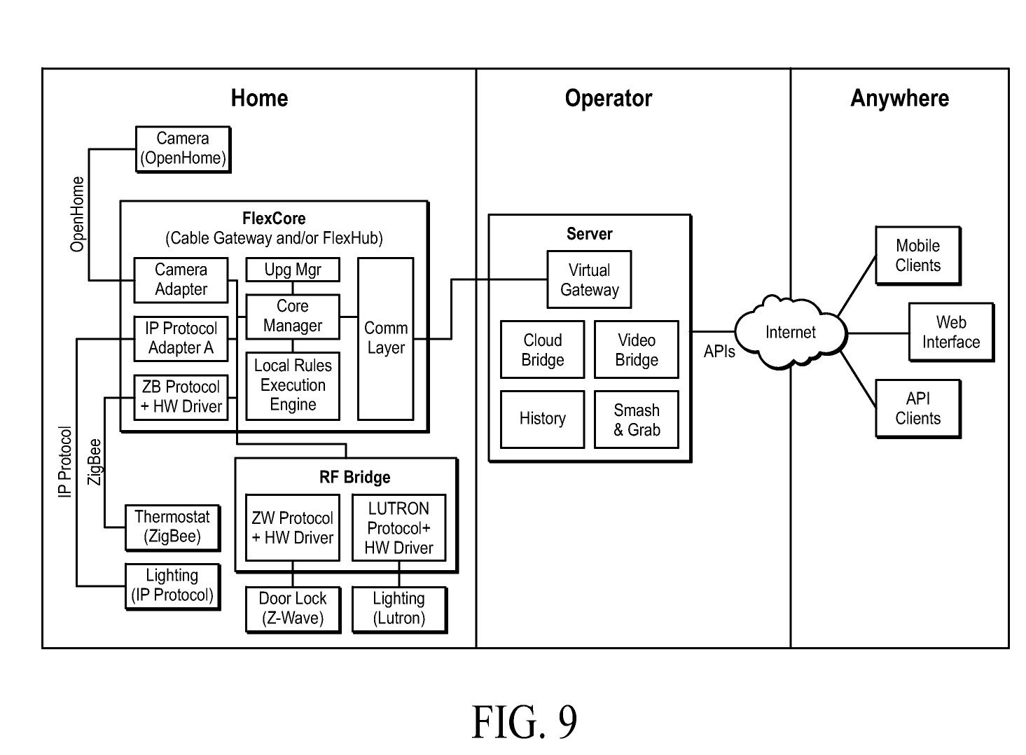

FIG. 9 is a block diagram of a system including a Cloud Hub and Virtual Gateway showing the premises, service provider, and mobile environments, under an embodiment. The system of an embodiment includes the gateway (Cloud Hub) in the premises (e.g., home, office, etc.), and the gateway is coupled to a LWGW in the operator (server/cloud) domain. The gateway includes one or more of a camera adapter to integrate premises cameras, an IP adapter to integrate premises IP devices, and a ZigBee protocol and hardware driver to integrate premises ZigBee devices. Components of the gateway of an embodiment are coupled to a radio frequency (RF) bridge as appropriate to a configuration of devices in the premises, and the RF bridge integrates additional premises devices (e.g., Z-Wave devices, proprietary devices, etc.) into the system.

The LWGW and cloud-based infrastructure of an embodiment uses an existing service provider infrastructure, security, performance, and APIs, along with system components that are separated into modules executed on distributed in-premises systesms. The LWGW and cloud-based infrastructure includes a pluggable architecture that enables new device protocols and RF technologies to be added without the need to overhaul the core infrastructure. Use of a relatively small memory footprint on the CPE enables the infrastructure to execute on many devices, and this refactoring of local versus cloud services provides a virtual device (e.g., Internet of Things (IOT), etc.) gateway service that pushes as much as possible to the cloud while maintaining local performance and offline capabilities.

The LWGW included in an embodiment is configured as the server-side abstraction for the Cloud Hub. The LWGW is subordinate to the gateway object, and interacts with the server and the Cloud Hub device in much the same way that a RISSecurityPanel class does. As such, an embodiment re-factors the common code out of RISSecurityPanel into a class that both RISSecurityPanel and the Cloud Hub device can use. A new device definition is created for this type of device, and various changes to the StandardGateway class to control and manage the additional communication channel with the new device.

The Session Server configuration uses a gateway registry service to route incoming UDP packets from the CPE to the proper LWGW instance via a one-to-one mapping of CPE-unique IDs to site IDs. With the addition of the Cloud Hub, a second CPE-unique ID is mapped to the same LWGW instance as the primary SMA client's CPE-unique ID. This is accomplished by leveraging the Device Registry, which maintains a mapping of CPE ID and device type to site ID. Further, the session server is modified to use this Device Registry to properly route income packets.

Regarding client application software or applications, the clients include UX additions to present the new Cloud Hub device. When the Cloud Hub is present, UX flow will potentially be different. For example, on a Cloud Hub system, Z-Wave devices are not added until the Cloud Hub is added. Also, deleting the Cloud Hub includes deleting the associated Z-Wave devices, and this uses special UX messaging. The activation app and the installer app will also need new flows for installing and managing these devices. The Cloud Hub Firmware of an example embodiment includes but is not limited to the following components: SMA Client: an always-on (i.e., always-TCP-connected) SMA client, supporting AES-256 encryption; ezwLib: port of the Icontrol embedded Z-Wave stack; Bootstrap Client for secure bootstrap of the master key, and then secure provisioning of the SMA Server connection information and initialization information; LED Driver to drive CPE LED that displays Server connectivity and Z-Wave status (CPE-dependent); Firmware Update Logic for fault-tolerant updates of the full CPE image (CPE-dependent); detailed/tunable error logging; Reset To Factory Default Logic for factory-default Z-Wave (erase node cache and security keys), WiFi (disable sandbox, reset SSID/PSK; CPE-dependent), and de-provision (erase SMA Server info).

In an example configuration, Server-CPE communication is over the SMAv1 protocol, except for bootstrapping and provisioning which uses the OpenHome “Off-Premise Bootstrap Procedure.” On the CPE, the OS and network layer (Wi-Fi sandbox, WPS, routing, etc.) are provided and managed by the CPE OEM (e.g., Sercomm). Wi-Fi provisioning and traffic is handled by the CPE OEM (e.g., Sercomm) without Cloud Hub intervention/signaling, except with respect to enabling/disabling and resetting to defaults.

The Cloud Hub device installation and bootstrap mechanism performs one or more of the following: associate the device with an existing site; securely deliver the SMA communication configuration, including master key, SMA server address, and network ports. An embodiment includes an off-premise bootstrapping procedure, also used for bootstrapping tunneling cameras, that includes a three-step process.

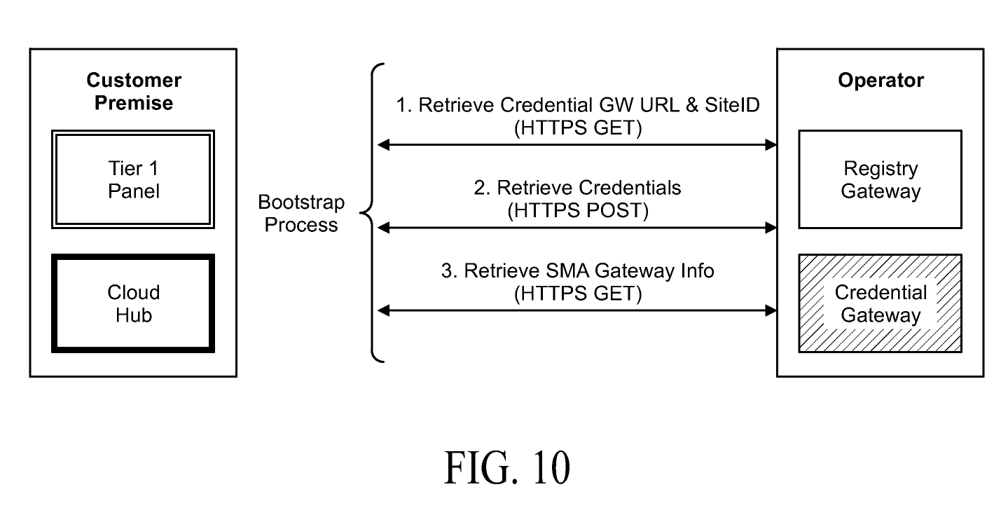

FIG. 10 is a flow diagram for device installation and bootstrapping, under an embodiment. The process for device installation and bootstrapping includes a first step that couples or connects the Cloud Hub to the Registry Gateway (e.g., via the pre-configured Registry Gateway URL) and retrieves its assigned siteID and the Credential Gateway URL. A second step includes the Cloud Hub retrieving its master key from the Credential Gateway using its siteID and Activation Key. The process comprises a third step in which the Cloud Hub retrieves Session Gateway Information from the Credential Gateway. At the end of the Bootstrap phase, the Cloud Hub has obtained its master key and its Session Gateway address from the iControl Gateway.

More particularly, the Cloud Hub retrieves its SiteID and Credential Gateway URL during the first step of the process.

| Purpose | Retrieve Credential Gateway URL and siteID using Cloud Hub Serial | |
|---|---|---|
| | Number as input | |
| Message | HTTPS GET /<Registry Gateway URL>/<Serial Number> HTTP/1.1 | |
| Format | | |
| Authentication | None | |
| Mandatory | Host | |
| Request | | |
| Headers | <registryEntry serial=“<Serial Number>” href=“/<Registry Gateway | |
| | URL>/<Serial Number>”> | |
| | <functions>...</functions > | |
| 200 OK | <siteId><siteID></siteId> | |
| response | | |
| | <gatewayUrl><Credential Gateway URL></gatewayUrl> | |
| | </registryEntry> | |
| Error | Standard HTTP response codes (e.g., 404) | |
| responses | | |
| Example | https://adminsirius3.icontrol.com/rest/icontrol/registry/serial/0060350402 | |
| Request | 6c | |
| | <registryEntry serial=“00:60:35:04:02:6c” | |
| | href=“rest/icontrol/registry/seria1/00603504026c”> | |
| | <functions count=“1”> | |
| | <function name=“delete” | |
| Example 200 | action=“/rest/icontrol/registry/seria1/00603504026c” | |
| OK Response | method=“DELETE”/> | |
| | </functions> | |
| | <siteId>00603504026c</siteId> | |
| | <gatewayUrl>http://gsess-sirius3.icontrol.com/gw</gatewayUrl> | |
| | </registryEntry> | |
| Variable Name | Format | Description/Notes |
| Registry Gateway | URL | URL Pre-configured in Cloud Hub |
| | | firmware |
| Serial Number | 12 byte hex string | Pre-configured in Cloud Hub |
| | | firmware |
| siteID | 12-20 digit alpha numeric | |
| | string | |
| gatewayUrl otherwise known as | URL prefix | Prefix to use for Pending |
| CredentialGatewayURL | protocol:host[:port]/path | Master Key and Connect Info |
| | | requests. |

The Cloud Hub retrieves its Pending Master Key when the Master Key is not already established from a previous successful Retreieve Credital procedure, during the second step of the process.

| Purpose | Retrieve device-specific Master Key using its siteID, serial number and | |
|---|---|---|
| | Activation Key as inputs | |
| | HTTPS POST/< | |
| Message | CredentialGatewayURL>/GatewayService/<siteID>/PendingDeviceKey | |
| Format | HTTP/1.1 | |
| Authentication | None | |
| Mandatory | Host, Content-Length, Content-Type (application/x-www-form- | |
| Request | urlencoded ) | |
| Headers | | |
| POST body | serial=<Serial Number>&activationkey=<ActivationKey> | |
| 200 OK | <pendingPaidKey method=“server” expires=“<pending master key | |
| response with | expiration epoch millisecs>” ts=“<current epoch millisecs>” | |
| pending | key=“<master key>” partner=“icontrol”/> | |
| master key | | |
| | Gateway responds with a method=“retry” if the Cloud Hub is not yet | |
| | activated within the system. Response includes timeout for retry. | |
| 200 OK | | |
| response with | <PendingPaidKey method=“retry” expires=“<retry epoch millisecs>” | |
| retry | ts=“<current epoch millisecs>” partner=“icontrol”/> | |
| Other HTTP | Standard HTTP error response codes for example 5xx indicate a | |
| responses | temporary server issue and Cloud Hub devices should perform an | |
| | automatic retry in randomized 10 minute backoff. | |
| Example | seria1=555500000010&activationkey=AABB12345678 | |
| POST body | | |
| Example 200 | <pendingPaidKey method=“server” expires=“1308892493528” | |
| OK with | ts=“1308849293540” key=“398341159498190458” partner=“icontrol”/> | |
| pending key | | |
| Response | | |
| Example 200 | <pendingPaidKey method=“retry” expires=“1308849242148” | |
| OK response | ts=“1308849122148” partner=“icontrol”/> | |
| with retry | | |
| Variable Name | Format | Description/Notes |
| CredentialGatewayURL | Hostname[:port] | Retrieved via Step 1 - Retrieve Gateway |
| | | URL and SiteID |
| siteID | 12 byte hexadecimal | Retrieved via Step 1 - Retrieve Gateway |
| | string | URL and SiteID |
| ActivationKey | 10+ digit alpha | Pre-configured in Cloud Hub, generated |
| | numeric string | by manufacturer and printed on device |
| ‘method’ (in 200 OK | String | “server” or “retry” |
| body) | | |
| ‘key’ (in 200 OK body) | Alphanumeric string | Pending key returned by Gateway in 200 |
| | | OK body |
| ‘ts’ (in 200 OK body) | Numeric string | Gateway's timestamp in UTC time |
| ‘expires’ (in 200 OK | Numeric string | UTC time when the current pending key |
| body) | | expires |
| Pending Key | Alphanumeric string | Initial key retrieved from Gateway that is |
| | | not yet confirmed with the Gateway. |
| | | Pending key becomes <SharedSecret> |
| SharedSecret or master | Alphanumeric string | after successful connection to Gateway |
| key | | (see below) |

While Cloud Hub activation is underway, the Gateway responds to a Cloud Hub's request for Credential with 200 OK including the PendingPaidKey XML body (with method=“server”) with a pending key field. The pending key field becomes active once the Cloud Hub couples or connects to the Gateway over the SMA channel and is authenticated by using the pending key to encrypt the initial SMA exchange. Once authenticated (via a successful SMA session with the Gateway), the key is no longer pending and instead becomes active, or otherwise known as the Cloud Hub's <SharedSecret> or master key. The active master key (“<SharedSecret>”) will not automatically expire; however, the Gateway may update a Cloud Hub's <SharedSecret>.

Once a pending key becomes active, subsequent requests for the PendingDeviceKey receive method=“retry” responses unless a new activation process is initiated (this can be done by administrators and installers via the iControl admin and portal applications).

If the Cloud Hub does not connect to the server over the SMA channel and get authenticated using the key by the “expires” time specified in the PendingPaidKey XML body, then the pending key will expire and no longer be valid. While Cloud Hub activation is underway, each request for the PendingPaidKey receives a different key in the response, causing the previous pending key to be replaced with the new one.

The Cloud Hub retrieves Session Gateway Info, which includes SMA Gateway address, during the third step of the process for device installation and bootstrapping.

| | |
|---|---|
| Purpose | Retrieve SMA Gateway hostname and port from Credential Gateway |
| Message | HTTPS GET /<gatewayUrl>/GatewayService/<siteID>/connectInfo |
| Format | HTTP/1.1 |
| Authentication | None |
| Mandatory | |
| Request | Host |
| Headers | |
| | <connectInfo> |
| | <session host=<Session Gateway host>port=[port] /><ris |
| | eventPort1=‘[port]’ eventPort2=‘[port]’ controlPort1=‘[port]’ |
| 200 OK | controlPort2=‘[port]”!> |
| response | <xmpp host=<XMPP Gateway host>port=[port] />(ignored) |
| | </connectInfo> |
| Error responses | Standard HTTP response codes (e.g., 404) |
| | <connectInfo> |
| | <session host=‘gsess-aristotleqap.icontrol.com’ port=‘433’/><ris |
| | eventPort1=‘11083’ eventPort2=‘11083’ controlPort1=‘11084’ |
| | controlPort2=‘11084’/> |
| Example 200 | <xmpp host=‘gsess-aristotleqap.icontrol.com’ port=‘5222’/><media |
| OK Response | ur1=‘https://media- |
| | aristotleqap.icontrol.com/gw/GatewayService’/></connectInfo> |

| Variable Name | Format | Description/Notes |
|---|---|---|
| gatewayUrl | https://hostname[:port]/path | Retrieved Via Step 1 - Retrieve |
| | | Gateway URL and SiteID |
| siteID | 12-20 char alpha | Retrieved Via Step 1 - Retrieve |
| | numericstring | Gateway URL and SiteID |
| XMPP Gateway | Hostname and port | These variables should be ignored by |
| host:port | IPAddress and port | the Cloud Hub. |
| | | Host and command port to use for |
| Session Gateway | Hostname | SMA communication with the |
| host | | Gateway. |
| session:port | port | This port variable should be ignored |
| | | by the Cloud Hub. |
| ris:eventPort1/2 | port | ports on Session Gateway host to |
| | | which SMA async events should be |
| | | sent |
| ris:controlPort1/2 | port | ports on Session Gateway host for |
| | | establishing the SMA control channel |

During the course of operation, the CPE executes the first and third steps of the installation process described above during each start-up/restart; the second step of the installation is executed when there is no previously stored master key. Hence, security credentials can be re-bootstrapped by invalidating the existing master key.

The installation process of an embodiment is as follows:
1) The user starts the “Add Control Hub” wizard.
2) The user is prompted to enter the Control Hub's Activation Key, printed on the device.
3) REST request generated: POST /rest/[partner]/nw/[siteId]/devices?technology=CSMAP&type=Icontrol_OneL ink_CH1000_controlhub&name=[name]&activationKey=[akey]
   a) Gateway derives the 12-hex-digit CPE serial number from the Activation Key
   b) Gateway validates the activation key. HTTP 403 is returned if activation key is incorrect
   c) Gateway calls the addDevice method on the gapp server to add LWG_SerComm_ControlHub_1000 with given serial to site.
      i) server detects the device type and populates registry
      ii) HTTP 409 is returned if the device cannot be added
      iii) HTTP 503 is returned if the device cannot be referenced after it was just recently created.
   d) Gateway puts the device into pending key state.
   e) Upon success, HTTP 201 is returned with the “Location” header pointing to relative URI of /rest/[partner]/nw/[netId]/instances/[indexId]
4) On device connection, the gateway updates device-auth/pending-expiry to −1 and device-auth/session-key with password and device/connection-status to connected.
5) Polls for the data point “connection-status” to change to “connected” in the data returned by a GET to the URL returned in step 3e.; if does not connect after 60 seconds, displays a timeout message (device has not connected—continue waiting or start over).
6) Upon detecting successful connection, IA displays a successful detection message to the user.

The LWGW of an embodiment is configured to maintain a single CPE coupling or connection. This coupling or connection is encapsulated and managed by the RISSecurityPanel class, but is not so limited.

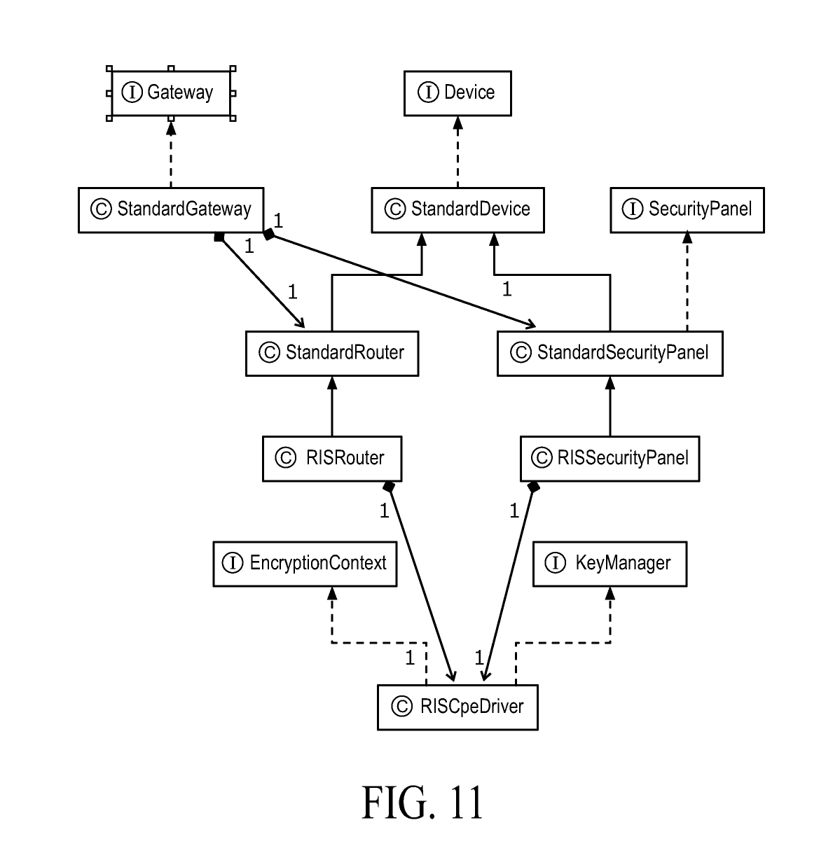

When configuring the system to include the Cloud Hub, an embodiment factors out the SMA communication and generic state-machine functionality from the RISSecurityPanel to create a new class RISCpeDriver, and a new subclass StandardDevice. The new subclass of StandardDevice, RISRouter, represents the Cloud Hub abstraction in the LWGW. A new class RISMCDevManager is also created. The StandardGateway and RISSecurityPanel classes are configured to perform monitor and control (M/C or MC) (e.g., Z-Wave) device operations via this class's public interface. The LWGW representation of CPE connection state is expanded to allow M/C operations to occur, even if the panel connection is down. FIG. 11 is a block diagram of the LWGW class structure, under an embodiment.

The following methods from RISSecurityPanel (some are over-rides from StandardSecurityPanel) are not panel-specific, but rather represent the functionality of any device which implements basic functionality of an SMA client. Therefore, an embodiment includes use of these methods for the RISRouter class: getSequenceNumber( ); setSequenceNumber( ); getMasterKey( ) getMasterKeyBytes( ) getSessionKey( ) getDeviceHardwareId; getSessionKeyBytes; setSessionKey; getPendingSessionKey; getPendingSessionKeyBytes; setPendingSessionKey; getSmsPinEncoded; getSmsPin; getSmsPinBytes; setSmsPin; getCommandKeyBytes; getWakeupSK; getConfigSK; getConfigSC; getSK; decryptAESCBC256; decryptAESCBC256IV; getType; encrypt; decrypt; getEncryptionContext; messageWasMissed; setConnected; handleUplinkData; refreshAesKey; setAesKey; isMCPointVariable; sendPendingData; doApplicationTick; getSessionId; startPremisesConnectionTest; getSMSTs; configMessage; wakeupMessage; startDiscovery; canceIDiscovery; getDiscoveryState; getSmaFraming; sendPremesisKeepalive; sendNoop; getIfConfig; setIfConfig; getLogFile; getSystemLogFile; setFirmwareUpgrade; getCpeVersion; getCpeFirmwareVersion; setFwUpgradeProgress; getFwUpgradeProgress; getFwUpgradeProgressString; getControllerId; getNextCommandTime; setNextCommandTime; sendDownRequest; setSyncNoAndCheckForMissedEvents; handleAsyncMessage; handleSessionResponseMessage; sendPremesisConfiguration; getSmsHeaders; sendTestSms; sendWakeupSms; setConnected; commandChannelReady; getConnectivityTestTimeout; getCpeStarter; getCommTest; setSilenceAllTroubles; setClearAllTroubles.

The following methods from RISSecurityPanel are related to M/C devices, and this functionality is handled by the RISRouter (Cloud Hub) class, when present. Hence an interface for them comes out of RISSecurityPanel to be implemented by the RISRouter class. The StandardGateway is configured to decide which class method to call based on the presence of a Cloud Hub: handleMCDiscoveryModeStatusReport; handleMCDeviceStatusReport; reportMCPointUpdate; hasMatchingDeviceNames; getDiscoveredMCDeviceName; doZWave; getMCDevices; getMCDevRoute; getMCDevRoutes; getMCPointValue; getMCPointValues; getMCPointConfigs; getMCPointConfig; setAllMCPointConfigs; setDeviceMCPointConfigs; setMCPointConfig; setMCPointValue; setMCPointValue; failMCCommand; getMCDeviceVersionString; renameDevice; removeDevice.

Commands (e.g., SMAv1) to be routed through the RISRouter class, when present, include but are not limited to the following: GET_MC_DEVICE_CONFIG; GET_MC_POINT_CONFIG; SET_MC_POINT_REPORT_CONFIG; GET_MC_POINT_STATUS; SET_MC_POINT_STATUS; GET_MC_DEVICE_USER_CODES; SET_MC_DEVICE_USER_CODES; REMOVE_MC_DEVICE_USER_CODES; LOCAL_PORT_PASSTHROUGH; REMOVE_MC_DEVICE; SET_MC_DEVICE_NAME; GET_MC_DEVICE_ROUTES.

System commands to be routed through the RISRouter class, when present, include but are not limited to the following: MC_MESH_RELEARN; GET_DISCOVERY_STATUS; SET_DISCOVERY_STATUS; GET_LOCAL_PORT_CONFIG; SET_LOCAL_PORT_CONFIG; GET_MESH_RELEARN_STATUS; RESET_MC_MODULE.

System commands to be conditionally routed to either RISRouter or RISSecurityPanel, include but are not limited to the following: UPGRADE_FIRMWARE; GET_LOG_FILE; GET_LOCAL_TIME; SET_LOCAL_TIME; GET_TIME_ZONE; SET_TIME_ZONE; GET_FIRMWARE_VERSION.

The Cloud Hub of an embodiment is a broadband-connected device, and it is configured to attempt to maintain an always-on TCP/IP connection with the server. Therefore, there is no need for a shoulder-tap mechanism. Likewise, no “wake-up” message is required because the Cloud Hub is effectively always awake. With conventional Tier-1 systems, the server tears down the TCP connection after several minutes of inactivity; for Cloud Hub, the TCP connection should stay up for as long as possible, with periodic server-originated SMA heartbeat messages (SMA Request Type 0), so that the CPE can supervise the connection as being truly active.

Incoming UDP messages from the CPE are routed to the LWGW instance associated with a given site ID. The session server uses the Gateway Registry, which is a one-to-one mapping of CPE-unique IDs to site IDs for this purpose. With the addition of the Cloud Hub, an embodiment includes a second CPE-unique ID that is mapped to the same site ID (LWGW instance) as the primary SMA client's CPE-unique ID. This is accomplished by leveraging a Device Registry service that maintains a mapping of CPE ID and device type to site ID. The session server is modified to use the following procedure upon receipt of a UDP packet:
1. Look up the received packet CPE-unique ID in the Gateway Registry. If a corresponding site ID is found, route the packet to the associated LWGW instance. This is a standard, non-Cloud Hub packet from the CPE's primary SMA Client.
2. If a corresponding site ID is not found in step 1, the session server will look up the received CPE-unique ID with a general Cloud Hub device type ID. If a correspond site ID is found, route the packet to the associated LWGW instance. If not site ID is found, the packet is discarded.

The Cloud Hub, UDP and TCP messages received from the CPE at the session server are sent to the correct LWGW via two REST endpoints, thereby allowing the receiving LWGW instance to run on a session server other than the one at which the message was received.

When a UDP SMA message arrives at a session server, if the LWGW corresponding to the CPE-unique ID message is not already running on the given session server, then the session server initiates a new LWGW instance there, and if the corresponding LWGW is currently running on another session server, it will be gracefully shut down. In this way, the LWGW can move from one session server to another.

Regarding the session server/LWGW routing mechanism of an embodiment, the Cloud Hub network traffic includes a mechanism in which incoming UDP messages to a first session server cause the first session server to determine if the LWGW is running on the first session server. If so, using a LocalRestClient, UDP messages are passed through to the LWGW via a rest endpoint that calls through to the handleAsyncMessage method of the RIS device; if not, LWGW routing cache is checked to determine which session server is hosting the LWGW. If a routing entry is found, then use AMQPRestClient to pass the UDP message through to the specific session server hosting the LWGW via the same rest endpoint that calls through to the handleAsyncMessage method of the RIS device. If no routing entry is found, or the session server returns 404 (e.g., stale routing entry), then the session server sends out a broadcast request using the AMQPRestClient to ask all session servers “who has this LWGW”. If a session server responds to the broadcast request, then the async event is sent to that session server following the method described herein. If no session server responds to the broadcast request, then the LWGW is started on this first session server.

In an embodiment, the Cloud Hub network traffic includes a mechanism in which incoming TCP messages to a first session server cause the first session server to determine if LWGW is running on the first session server. If LWGW is not running on the first session server, LWGW routing cache is checked to determine which session server is hosting the LWGW and the TCP message is passed through accordingly, but using a different rest endpoint than UDP message handling. In the rest endpoint call, the name of the session server with the TCP connection is sent along with the request. When the LWGW receives TCP messages through the rest endpoint, it tracks the name of the session server with the TCP connection.

When the LWGW sends a command over the TCP coupling or connection in an embodiment, it sends a command via the AMQPRestClient to the session server hosting the TCP connection. It has this name saved from when it received the first TCP message for the given connection. If the TCP session server hostname is not known, or responds with a message indicating the TCP connection no longer present, then the LWGW sends out a broadcast request using the AMQPRestClient to ask all session servers “who has this TCP connection”. If any session server responds to the broadcast request, then the LWGW sends the command to that session server following the method described above. If no session server responds to the broadcast request, then the LWGW queues the command for a pre-specified time period.

The system of an embodiment including the Cloud Hub and Virtual Gateway as described in detail herein includes one or more components of the “integrated security system” described in detail in the Related Applications, which are incorporated by reference herein. An example of the “integrated security system” is available as one or more of the numerous systems or platforms available from iControl Networks, Inc., Redwood City, Calif. The system of an embodiment described herein incorporates one or more components of the “integrated security system”. The system of an embodiment described herein is coupled to one or more components of the “integrated security system”. The system of an embodiment described herein integrates with one or more components of the “integrated security system”.

More particularly, the methods and processes of the integrated security system, and hence the full functionality, can be implemented in the system described herein including the Cloud Hub and Virtual Gateway. Therefore, embodiments of the systems described herein integrate broadband and mobile access and control with conventional security systems and premise devices to provide a tri-mode security network (broadband, cellular/GSM, POTS access) that enables users to remotely stay connected to their premises. The integrated security system, while delivering remote premise monitoring and control functionality to conventional monitored premise protection, complements existing premise protection equipment. The integrated security system integrates into the premise network and couples wirelessly with the conventional security panel, enabling broadband access to premise security systems. Automation devices (cameras, lamp modules, thermostats, etc.) can be added, enabling users to remotely see live video and/or pictures and control home devices via their personal web portal or webpage, mobile phone, and/or other remote client device. Users can also receive notifications via email or text message when happenings occur, or do not occur, in their home.

In accordance with the embodiments described herein, a wireless system (e.g., radio frequency (RF)) is provided that enables a security provider or consumer to extend the capabilities of an existing RF-capable security system or a non-RF-capable security system that has been upgraded to support RF capabilities. The system includes an RF-capable Gateway device (physically located within RF range of the RF-capable security system) and associated software operating on the Gateway device. The system also includes a web server, application server, and remote database providing a persistent store for information related to the system.

The security systems of an embodiment, referred to herein as the iControl security system or integrated security system, extend the value of traditional home security by adding broadband access and the advantages of remote home monitoring and home control through the formation of a security network including components of the integrated security system integrated with a conventional premise security system and a premise local area network (LAN). With the integrated security system, conventional home security sensors, cameras, touchscreen keypads, lighting controls, and/or Internet Protocol (IP) devices in the home (or business) become connected devices that are accessible anywhere in the world from a web browser, mobile phone or through content-enabled touchscreens. The integrated security system experience allows security operators to both extend the value proposition of their monitored security systems and reach new consumers that include broadband users interested in staying connected to their family, home and property when they are away from home.

The integrated security system of an embodiment includes security servers (also referred to herein as iConnect servers or security network servers) and an iHub gateway (also referred to herein as the gateway, the iHub, or the iHub client) that couples or integrates into a home network (e.g., LAN) and communicates directly with the home security panel, in both wired and wireless installations. The security system of an embodiment automatically discovers the security system components (e.g., sensors, etc.) belonging to the security system and connected to a control panel of the security system and provides consumers with full two-way access via web and mobile portals. The gateway supports various wireless protocols and can interconnect with a wide range of control panels offered by security system providers. Service providers and users can then extend the system's capabilities with the additional IP cameras, lighting modules or security devices such as interactive touchscreen keypads. The integrated security system adds an enhanced value to these security systems by enabling consumers to stay connected through email and SMS alerts, photo push, event-based video capture and rule-based monitoring and notifications. This solution extends the reach of home security to households with broadband access.

The integrated security system builds upon the foundation afforded by traditional security systems by layering broadband and mobile access, IP cameras, interactive touchscreens, and an open approach to home automation on top of traditional security system configurations. The integrated security system is easily installed and managed by the security operator, and simplifies the traditional security installation process, as described below.

The integrated security system provides an open systems solution to the home security market. As such, the foundation of the integrated security system customer premises equipment (CPE) approach has been to abstract devices, and allows applications to manipulate and manage multiple devices from any vendor. The integrated security system DeviceConnect technology that enables this capability supports protocols, devices, and panels from GE Security and Honeywell, as well as consumer devices using Z-Wave, IP cameras (e.g., Ethernet, wife, and Homeplug), and IP touchscreens. The DeviceConnect is a device abstraction layer that enables any device or protocol layer to interoperate with integrated security system components. This architecture enables the addition of new devices supporting any of these interfaces, as well as add entirely new protocols.

The benefit of DeviceConnect is that it provides supplier flexibility. The same consistent touchscreen, web, and mobile user experience operate unchanged on whatever security equipment selected by a security system provider, with the system provider's choice of IP cameras, backend data center and central station software.

The integrated security system provides a complete system that integrates or layers on top of a conventional host security system available from a security system provider. The security system provider therefore can select different components or configurations to offer (e.g., CDMA, GPRS, no cellular, etc.) as well as have iControl modify the integrated security system configuration for the system provider's specific needs (e.g., change the functionality of the web or mobile portal, add a GE or Honeywell-compatible TouchScreen, etc.).

The integrated security system integrates with the security system provider infrastructure for central station reporting directly via Broadband and GPRS alarm transmissions. Traditional dial-up reporting is supported via the standard panel connectivity. Additionally, the integrated security system provides interfaces for advanced functionality to the CMS, including enhanced alarm events, system installation optimizations, system test verification, video verification, 2-way voice over IP and GSM.

The integrated security system is an IP centric system that includes broadband connectivity so that the gateway augments the existing security system with broadband and GPRS connectivity. If broadband is down or unavailable GPRS may be used, for example. The integrated security system supports GPRS connectivity using an optional wireless package that includes a GPRS modem in the gateway. The integrated security system treats the GPRS connection as a higher cost though flexible option for data transfers. In an embodiment the GPRS connection is only used to route alarm events (e.g., for cost), however the gateway can be configured (e.g., through the iConnect server interface) to act as a primary channel and pass any or all events over GPRS.

Consequently, the integrated security system does not interfere with the current plain old telephone service (POTS) security panel interface. Alarm events can still be routed through POTS; however the gateway also allows such events to be routed through a broadband or GPRS connection as well. The integrated security system provides a web application interface to the CSR tool suite as well as XML web services interfaces for programmatic integration between the security system provider's existing call center products. The integrated security system includes, for example, APIs that allow the security system provider to integrate components of the integrated security system into a custom call center interface. The APIs include XML web service APIs for integration of existing security system provider call center applications with the integrated security system service. All functionality available in the CSR Web application is provided with these API sets. The Java and XML-based APIs of the integrated security system support provisioning, billing, system administration, CSR, central station, portal user interfaces, and content management functions, to name a few. The integrated security system can provide a customized interface to the security system provider's billing system, or alternatively can provide security system developers with APIs and support in the integration effort.

The integrated security system provides or includes business component interfaces for provisioning, administration, and customer care to name a few. Standard templates and examples are provided with a defined customer professional services engagement to help integrate OSS/BSS systems of a Service Provider with the integrated security system.

The integrated security system components support and allow for the integration of customer account creation and deletion with a security system. The iConnect APIs provides access to the provisioning and account management system in iConnect and provide full support for account creation, provisioning, and deletion. Depending on the requirements of the security system provider, the iConnect APIs can be used to completely customize any aspect of the integrated security system backend operational system.

The integrated security system includes a gateway that supports the following standards-based interfaces, to name a few: Ethernet IP communications via Ethernet ports on the gateway, and standard XML/TCP/IP protocols and ports are employed over secured SSL sessions; USB 2.0 via ports on the gateway; 802.11b/g/n IP communications; GSM/GPRS RF WAN communications; CDMA 1xRTT RF WAN communications (optional, can also support EVDO and 3G technologies).

The gateway supports the following proprietary interfaces, to name a few: interfaces including Dialog RF network (319.5 MHz) and RS485 Superbus 2000 wired interface; RF mesh network (908 MHz); and interfaces including RF network (345 MHz) and RS485/RS232bus wired interfaces.

Regarding security for the IP communications (e.g., authentication, authorization, encryption, anti-spoofing, etc), the integrated security system uses SSL to encrypt all IP traffic, using server and client-certificates for authentication, as well as authentication in the data sent over the SSL-encrypted channel. For encryption, integrated security system issues public/private key pairs at the time/place of manufacture, and certificates are not stored in any online storage in an embodiment.

The integrated security system does not need any special rules at the customer premise and/or at the security system provider central station because the integrated security system makes outgoing connections using TCP over the standard HTTP and HTTPS ports. Provided outbound TCP connections are allowed then no special requirements on the firewalls are necessary.

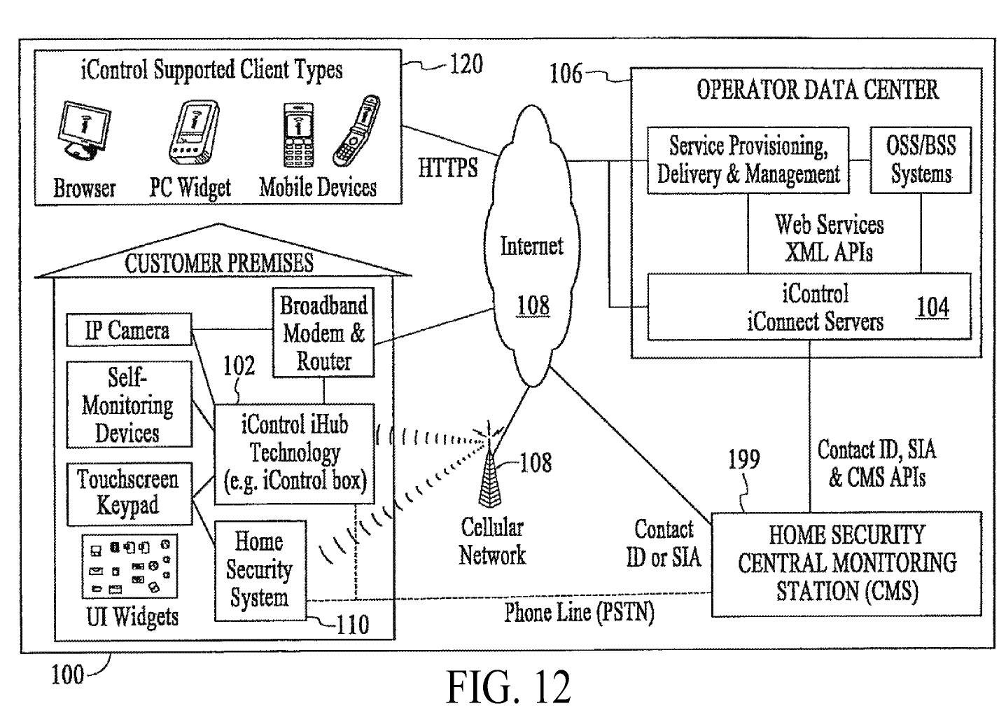

FIG. 12 is a block diagram of the integrated security system 100, under an embodiment. The integrated security system 100 of an embodiment includes the gateway 102 and the security servers 104 coupled to the conventional home security system 110. At a customer's home or business, the gateway 102 connects and manages the diverse variety of home security and self-monitoring devices. The gateway 102 communicates with the iConnect Servers 104 located in the service provider's data center 106 (or hosted in integrated security system data center), with the communication taking place via a communication network 108 or other network (e.g., cellular network, internet, etc.). These servers 104 manage the system integrations necessary to deliver the integrated system service described herein. The combination of the gateway 102 and the iConnect servers 104 enable a wide variety of remote client devices 120 (e.g., PCs, mobile phones and PDAs) allowing users to remotely stay in touch with their home, business and family. In addition, the technology allows home security and self-monitoring information, as well as relevant third party content such as traffic and weather, to be presented in intuitive ways within the home, such as on advanced touchscreen keypads.

The integrated security system service (also referred to as iControl service) can be managed by a service provider via browser-based Maintenance and Service Management applications that are provided with the iConnect Servers. Or, if desired, the service can be more tightly integrated with existing OSS/BSS and service delivery systems via the iConnect web services-based XML APIs.

The integrated security system service can also coordinate the sending of alarms to the home security Central Monitoring Station (CMS) 199. Alarms are passed to the CMS 199 using standard protocols such as Contact ID or SIA and can be generated from the home security panel location as well as by iConnect server 104 conditions (such as lack of communications with the integrated security system). In addition, the link between the security servers 104 and CMS 199 provides tighter integration between home security and self-monitoring devices and the gateway 102. Such integration enables advanced security capabilities such as the ability for CMS personnel to view photos taken at the time a burglary alarm was triggered. For maximum security, the gateway 102 and iConnect servers 104 support the use of a mobile network (both GPRS and CDMA options are available) as a backup to the primary broadband connection.

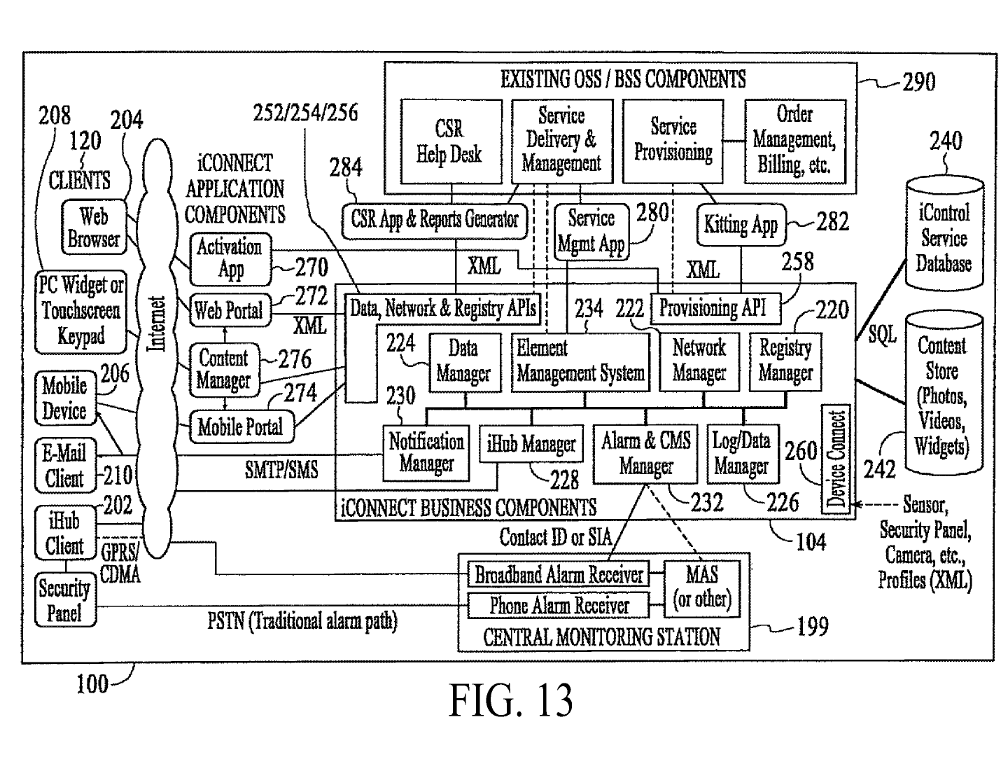

The integrated security system service is delivered by hosted servers running software components that communicate with a variety of client types while interacting with other systems. FIG. 13 is a block diagram of components of the integrated security system 100, under an embodiment. Following is a more detailed description of the components.

The iConnect servers 104 support a diverse collection of clients 120 ranging from mobile devices, to PCs, to in-home security devices, to a service provider's internal systems. Most clients 120 are used by end-users, but there are also a number of clients 120 that are used to operate the service.

Clients 120 used by end-users of the integrated security system 100 include, but are not limited to, the following:

Clients based on gateway client applications 202 (e.g., a processor-based device running the gateway technology that manages home security and automation devices).

A web browser 204 accessing a Web Portal application, performing end-user configuration and customization of the integrated security system service as well as monitoring of in-home device status, viewing photos and video, etc. Device and user management can also be performed by this portal application.

A mobile device 206 (e.g., PDA, mobile phone, etc.) accessing the integrated security system Mobile Portal. This type of client 206 is used by end-users to view system status and perform operations on devices (e.g., turning on a lamp, arming a security panel, etc.) rather than for system configuration tasks such as adding a new device or user.

PC or browser-based “widget” containers 208 that present integrated security system service content, as well as other third-party content, in simple, targeted ways (e.g. a widget that resides on a PC desktop and shows live video from a single in-home camera). “Widget” as used herein means applications or programs in the system.

Touchscreen home security keypads 208 and advanced in-home devices that present a variety of content widgets via an intuitive touchscreen user interface.

Notification recipients 210 (e.g., cell phones that receive SMS-based notifications when certain events occur (or don't occur), email clients that receive an email message with similar information, etc.).

Custom-built clients (not shown) that access the iConnect web services XML API to interact with users' home security and self-monitoring information in new and unique ways. Such clients could include new types of mobile devices, or complex applications where integrated security system content is integrated into a broader set of application features.

In addition to the end-user clients, the iConnect servers 104 support PC browser-based Service Management clients that manage the ongoing operation of the overall service. These clients run applications that handle tasks such as provisioning, service monitoring, customer support and reporting.

There are numerous types of server components of the iConnect servers 104 of an embodiment including, but not limited to, the following: Business Components which manage information about all of the home security and self-monitoring devices; End-User Application Components which display that information for users and access the Business Components via published XML APIs; and Service Management Application Components which enable operators to administer the service (these components also access the Business Components via the XML APIs, and also via published SNMP MIBs).

The server components provide access to, and management of, the objects associated with an integrated security system installation. The top-level object is the “network.” It is a location where a gateway 102 is located, and is also commonly referred to as a site or premises; the premises can include any type of structure (e.g., home, office, warehouse, etc.) at which a gateway 102 is located. Users can only access the networks to which they have been granted permission. Within a network, every object monitored by the gateway 102 is called a device. Devices include the sensors, cameras, home security panels and automation devices, as well as the controller or processor-based device running the gateway applications.

Various types of interactions are possible between the objects in a system. Automations define actions that occur as a result of a change in state of a device. For example, take a picture with the front entry camera when the front door sensor changes to “open”. Notifications are messages sent to users to indicate that something has occurred, such as the front door going to “open” state, or has not occurred (referred to as an iWatch notification). Schedules define changes in device states that are to take place at predefined days and times. For example, set the security panel to “Armed” mode every weeknight at 11:00pm.

The iConnect Business Components are responsible for orchestrating all of the low-level service management activities for the integrated security system service. They define all of the users and devices associated with a network (site), analyze how the devices interact, and trigger associated actions (such as sending notifications to users). All changes in device states are monitored and logged. The Business Components also manage all interactions with external systems as required, including sending alarms and other related self-monitoring data to the home security Central Monitoring System (CMS) 199. The Business Components are implemented as portable Java J2EE Servlets, but are not so limited.

The following iConnect Business Components manage the main elements of the integrated security system service, but the embodiment is not so limited:
A Registry Manager 220 defines and manages users and networks. This component is responsible for the creation, modification and termination of users and networks. It is also where a user's access to networks is defined.
A Network Manager 222 defines and manages security and self-monitoring devices that are deployed on a network (site). This component handles the creation, modification, deletion and configuration of the devices, as well as the creation of automations, schedules and notification rules associated with those devices.
A Data Manager 224 manages access to current and logged state data for an existing network and its devices. This component specifically does not provide any access to network management capabilities, such as adding new devices to a network, which are handled exclusively by the Network Manager 222.
To achieve optimal performance for all types of queries, data for current device states is stored separately from historical state data (a.k.a. “logs”) in the database. A Log Data Manager 226 performs ongoing transfers of current device state data to the historical data log tables.

Additional iConnect Business Components handle direct communications with certain clients and other systems, for example:
An iHub Manager 228 directly manages all communications with gateway clients, including receiving information about device state changes, changing the configuration of devices, and pushing new versions of the gateway client to the hardware it is running on.
A Notification Manager 230 is responsible for sending all notifications to clients via SMS (mobile phone messages), email (via a relay server like an SMTP email server), etc.
An Alarm and CMS Manager 232 sends critical server-generated alarm events to the home security Central Monitoring Station (CMS) and manages all other communications of integrated security system service data to and from the CMS.
The Element Management System (EMS) 234 is an iControl Business Component that manages all activities associated with service installation, scaling and monitoring, and filters and packages service operations data for use by service management applications. The SNMP MIBs published by the EMS can also be incorporated into any third party monitoring system if desired.

The iConnect Business Components store information about the objects that they manage in the iControl Service Database 240 and in the iControl Content Store 242. The iControl Content Store is used to store media objects like video, photos and widget content, while the Service Database stores information about users, networks, and devices. Database interaction is performed via a JDBC interface. For security purposes, the Business Components manage all data storage and retrieval.

The iControl Business Components provide web services-based APIs that application components use to access the Business Components' capabilities. Functions of application components include presenting integrated security system service data to end-users, performing administrative duties, and integrating with external systems and back-office applications.

The primary published APIs for the iConnect Business Components include, but are not limited to, the following:
A Registry Manager API 252 provides access to the Registry Manager Business Component's functionality, allowing management of networks and users.
A Network Manager API 254 provides access to the Network Manager Business Component's functionality, allowing management of devices on a network.
A Data Manager API 256 provides access to the Data Manager Business Component's functionality, such as setting and retrieving (current and historical) data about device states.

A Provisioning API 258 provides a simple way to create new networks and configure initial default properties.

Each API of an embodiment includes two modes of access: Java API or XML API. The XML APIs are published as web services so that they can be easily accessed by applications or servers over a network. The Java APIs are a programmer-friendly wrapper for the XML APIs. Application components and integrations written in Java should generally use the Java APIs rather than the XML APIs directly.

The iConnect Business Components also have an XML-based interface 260 for quickly adding support for new devices to the integrated security system. This interface 260, referred to as DeviceConnect 260, is a flexible, standards-based mechanism for defining the properties of new devices and how they can be managed. Although the format is flexible enough to allow the addition of any type of future device, pre-defined XML profiles are currently available for adding common types of devices such as sensors (SensorConnect), home security panels (PanelConnect) and IP cameras (CameraConnect).

The iConnect End-User Application Components deliver the user interfaces that run on the different types of clients supported by the integrated security system service.

The components are written in portable Java J2EE technology (e.g., as Java Servlets, as JavaServer Pages (JSPs), etc.) and they all interact with the iControl Business Components via the published APIs.

The following End-User Application Components generate CSS-based HTML/JavaScript that is displayed on the target client. These applications can be dynamically branded with partner-specific logos and URL links (such as Customer Support, etc.). The End-User Application Components of an embodiment include, but are not limited to, the following:
An iControl Activation Application 270 that delivers the first application that a user sees when they set up the integrated security system service. This wizard-based web browser application securely associates a new user with a purchased gateway and the other devices included with it as a kit (if any). It primarily uses functionality published by the Provisioning API.
An iControl Web Portal Application 272 runs on PC browsers and delivers the web-based interface to the integrated security system service. This application allows users to manage their networks (e.g. add devices and create automations) as well as to view/change device states, and manage pictures and videos. Because of the wide scope of capabilities of this application, it uses three different Business Component APIs that include the Registry Manager API, Network Manager API, and Data Manager API, but the embodiment is not so limited.
An iControl Mobile Portal 274 is a small-footprint web-based interface that runs on mobile phones and PDAs. This interface is optimized for remote viewing of device states and pictures/videos rather than network management. As such, its interaction with the Business Components is primarily via the Data Manager API.
Custom portals and targeted client applications can be provided that leverage the same Business Component APIs used by the above applications.
A Content Manager Application Component 276 delivers content to a variety of clients. It sends multimedia-rich user interface components to widget container clients (both PC and browser-based), as well as to advanced touchscreen keypad clients. In addition to providing content directly to end-user devices, the Content Manager 276 provides widget-based user interface components to satisfy requests from other Application Components such as the iControl Web 272 and Mobile 274 portals.

A number of Application Components are responsible for overall management of the service. These pre-defined applications, referred to as Service Management Application Components, are configured to offer off-the-shelf solutions for production management of the integrated security system service including provisioning, overall service monitoring, customer support, and reporting, for example. The Service Management Application Components of an embodiment include, but are not limited to, the following:
A Service Management Application 280 allows service administrators to perform activities associated with service installation, scaling and monitoring/alerting. This application interacts heavily with the Element Management System (EMS) Business Component to execute its functionality, and also retrieves its monitoring data from that component via protocols such as SNMP MIBs.
A Kitting Application 282 is used by employees performing service provisioning tasks. This application allows home security and self-monitoring devices to be associated with gateways during the warehouse kitting process.
A CSR Application and Report Generator 284 is used by personnel supporting the integrated security system service, such as CSRs resolving end-user issues and employees enquiring about overall service usage. Pushes of new gateway firmware to deployed gateways is also managed by this application.

The iConnect servers 104 also support custom-built integrations with a service provider's existing OSS/BSS, CSR and service delivery systems 290. Such systems can access the iConnect web services XML API to transfer data to and from the iConnect servers 104. These types of integrations can compliment or replace the PC browser-based Service Management applications, depending on service provider needs.

As described above, the integrated security system of an embodiment includes a gateway, or iHub. The gateway of an embodiment includes a device that is deployed in the home or business and couples or connects the various third-party cameras, home security panels, sensors and devices to the iConnect server over a WAN connection as described in detail herein. The gateway couples to the home network and communicates directly with the home security panel in both wired and wireless sensor installations. The gateway is configured to be low-cost, reliable and thin so that it complements the integrated security system network-based architecture.

The gateway supports various wireless protocols and can interconnect with a wide range of home security control panels. Service providers and users can then extend the system's capabilities by adding IP cameras, lighting modules and additional security devices. The gateway is configurable to be integrated into many consumer appliances, including set-top boxes, routers and security panels. The small and efficient footprint of the gateway enables this portability and versatility, thereby simplifying and reducing the overall cost of the deployment.

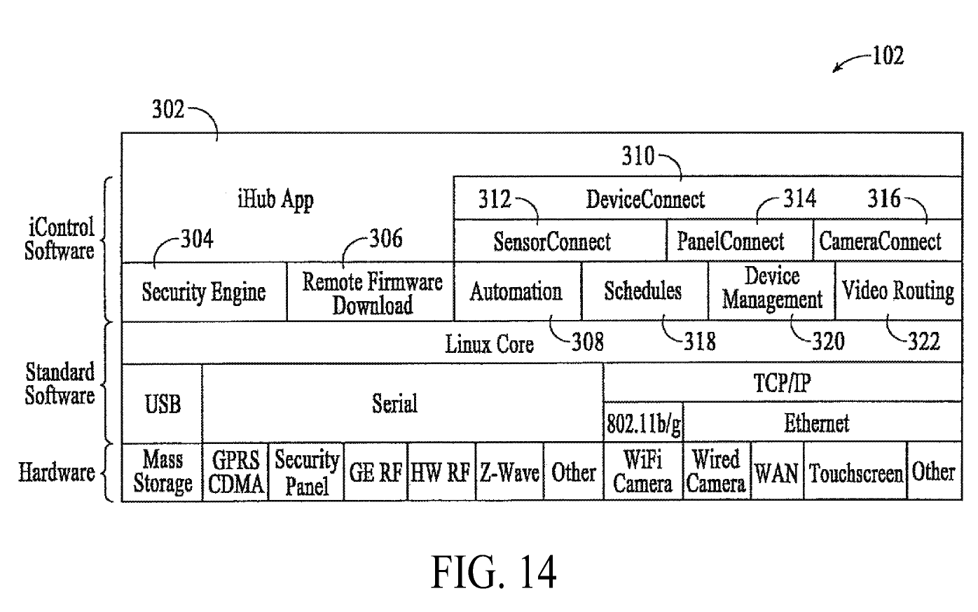

FIG. 14 is a block diagram of the gateway 102 including gateway software or applications, under an embodiment. The gateway software architecture is relatively thin and efficient, thereby simplifying its integration into other consumer appliances such as set-top boxes, routers, touch screens and security panels. The software architecture also provides a high degree of security against unauthorized access. This section describes the various key components of the gateway software architecture.

The gateway application layer 302 is the main program that orchestrates the operations performed by the gateway. The Security Engine 304 provides robust protection against intentional and unintentional intrusion into the integrated security system network from the outside world (both from inside the premises as well as from the WAN). The Security Engine 304 of an embodiment comprises one or more sub-modules or components that perform functions including, but not limited to, the following:
Encryption including 128-bit SSL encryption for gateway and iConnect server communication to protect user data privacy and provide secure communication.
Bi-directional authentication between the gateway and iConnect server in order to prevent unauthorized spoofing and attacks. Data sent from the iConnect server to the gateway application (or vice versa) is digitally signed as an additional layer of security. Digital signing provides both authentication and validation that the data has not been altered in transit.
Camera SSL encapsulation because picture and video traffic offered by off-the-shelf networked IP cameras is not secure when traveling over the Internet. The gateway provides for 128-bit SSL encapsulation of the user picture and video data sent over the internet for complete user security and privacy.
802.11 b/g/n with WPA-2 security to ensure that wireless camera communications always takes place using the strongest available protection.
A gateway-enabled device is assigned a unique activation key for activation with an iConnect server. This ensures that only valid gateway-enabled devices can be activated for use with the specific instance of iConnect server in use. Attempts to activate gateway-enabled devices by brute force are detected by the Security Engine. Partners deploying gateway-enabled devices have the knowledge that only a gateway with the correct serial number and activation key can be activated for use with an iConnect server. Stolen devices, devices attempting to masquerade as gateway-enabled devices, and malicious outsiders (or insiders as knowledgeable but nefarious customers) cannot effect other customers' gateway-enabled devices.

As standards evolve, and new encryption and authentication methods are proven to be useful, and older mechanisms proven to be breakable, the security manager can be upgraded “over the air” to provide new and better security for communications between the iConnect server and the gateway application, and locally at the premises to remove any risk of eavesdropping on camera communications.

A Remote Firware Download module 306 allows for seamless and secure updates to the gateway firmware through the iControl Maintenance Application on the server 104, providing a transparent, hassle-free mechanism for the service provider to deploy new features and bug fixes to the installed user base. The firmware download mechanism is tolerant of connection loss, power interruption and user interventions (both intentional and unintentional). Such robustness reduces down time and customer support issues. Gateway firmware can be remotely download either for one gateway at a time, a group of gateways, or in batches.

The Automations engine 308 manages the user-defined rules of interaction between the different devices (e.g. when door opens turn on the light). Though the automation rules are programmed and reside at the portal/server level, they are cached at the gateway level in order to provide short latency between device triggers and actions.

DeviceConnect 310 includes definitions of all supported devices (e.g., cameras, security panels, sensors, etc.) using a standardized plug-in architecture. The DeviceConnect module 310 offers an interface that can be used to quickly add support for any new device as well as enabling interoperability between devices that use different technologies/protocols. For common device types, pre-defined sub-modules have been defined, making supporting new devices of these types even easier. SensorConnect 312 is provided for adding new sensors, CameraConnect 316 for adding IP cameras, and PanelConnect 314 for adding home security panels.

The Schedules engine 318 is responsible for executing the user defined schedules (e.g., take a picture every five minutes; every day at 8am set temperature to 65 degrees Fahrenheit, etc.). Though the schedules are programmed and reside at the iConnect server level they are sent to the scheduler within the gateway application. The Schedules Engine 318 then interfaces with SensorConnect 312 to ensure that scheduled events occur at precisely the desired time.

The Device Management module 320 is in charge of all discovery, installation and configuration of both wired and wireless IP devices (e.g., cameras, etc.) coupled or connected to the system. Networked IP devices, such as those used in the integrated security system, require user configuration of many IP and security parameters—to simplify the user experience and reduce the customer support burden, the device management module of an embodiment handles the details of this configuration. The device management module also manages the video routing module described below.

The video routing engine 322 is responsible for delivering seamless video streams to the user with zero-configuration. Through a multi-step, staged approach the video routing engine uses a combination of UPnP port-forwarding, relay server routing and STUN/TURN peer-to-peer routing.

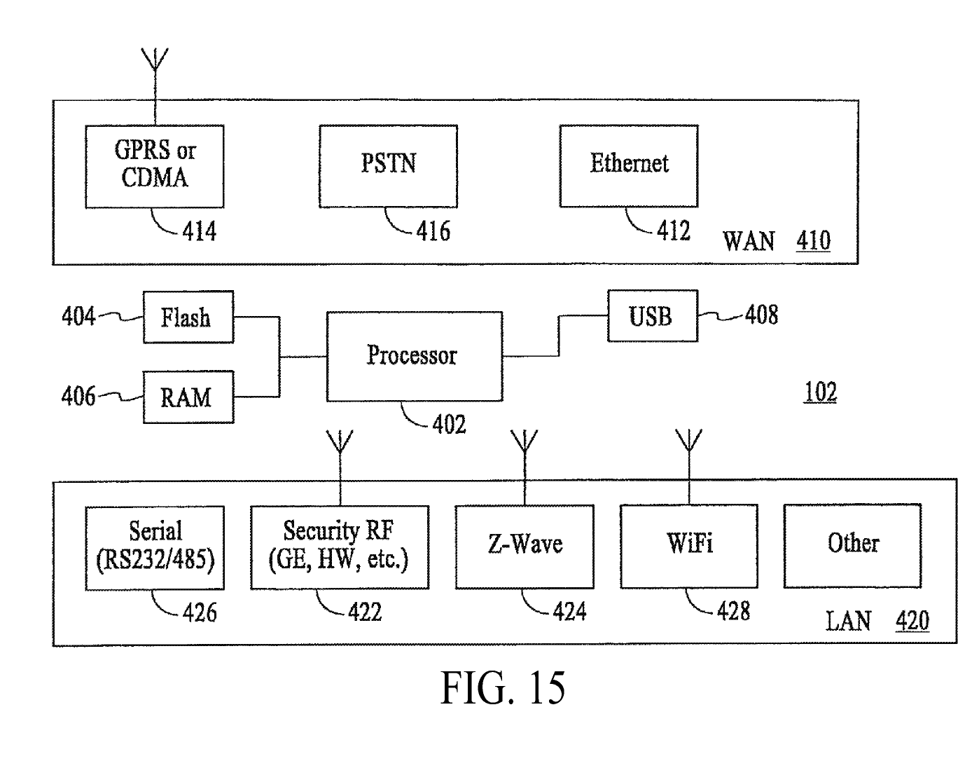

FIG. 15 is a block diagram of components of the gateway 102, under an embodiment. Depending on the specific set of functionality desired by the service provider deploying the integrated security system service, the gateway 102 can use any of a number of processors 402, due to the small footprint of the gateway application firmware. In an embodiment, the gateway could include the Broadcom BCM5354 as the processor for example. In addition, the gateway 102 includes memory (e.g., FLASH 404, RAM 406, etc.) and any number of input/output (I/O) ports 408.

Referring to the WAN portion 410 of the gateway 102, the gateway 102 of an embodiment can communicate with the iConnect server using a number of communication types and/or protocols, for example Broadband 412, GPRS 414 and/or Public Switched Telephone Network (PTSN) 416 to name a few. In general, broadband communication 412 is the primary means of connection between the gateway 102 and the iConnect server 104 and the GPRS/CDMA 414 and/or PSTN 416 interfaces acts as back-up for fault tolerance in case the user's broadband connection fails for whatever reason, but the embodiment is not so limited.

Referring to the LAN portion 420 of the gateway 102, various protocols and physical transceivers can be used to communicate to off-the-shelf sensors and cameras. The gateway 102 is protocol-agnostic and technology-agnostic and as such can easily support almost any device networking protocol. The gateway 102 can, for example, support GE and Honeywell security RF protocols 422, Z-Wave 424, serial (RS232 and RS485) 426 for direct connection to security panels as well as WiFi 428 (802.11 b/g) for communication to WiFi cameras.

Embodiments include a system comprising a bridge server configured to exchange event data and control data with a plurality of premises devices installed in a premises. The plurality of premises devices includes a plurality of data protocols. The system includes an application server coupled to the bridge server and configured to exchange the event data and the control data with the bridge server. The application server includes a plurality of virtual devices comprising logical models corresponding to the plurality of premises devices and configured to use the event data and the control data to maintain state of the plurality of premises devices. The application server includes a rules engine configured to control interaction among the plurality of premises devices. The system includes an application engine coupled to the application server and configured to communicate with a device application. The device application is configured for execution when installed on a remote device. The device application is configured to present a user interface at the remote device. The user interface is configured to present the event data and state of the plurality of premises devices and receive as input the control data of the plurality of premises devices.

Embodiments include a system comprising: a bridge server configured to exchange event data and control data with a plurality of premises devices installed in a premises, wherein the plurality of premises devices include a plurality of data protocols; an application server coupled to the bridge server and configured to exchange the event data and the control data with the bridge server, wherein the application server includes a plurality of virtual devices comprising logical models corresponding to the plurality of premises devices and configured to use the event data and the control data to maintain state of the plurality of premises devices, wherein the application server includes a rules engine configured to control interaction among the plurality of premises devices; and an application engine coupled to the application server and configured to communicate with a device application, wherein the device application is configured for execution when installed on a remote device, wherein the device application is configured to present a user interface at the remote device, wherein the user interface is configured to present the event data and state of the plurality of premises devices and receive as input the control data of the plurality of premises devices.

The bridge server includes an event bus coupled to a plurality of device interfaces, wherein each device interface is configured to transfer the event data and the control data between a corresponding premises device and the event bus.

Each device interface is specific to a protocol of the corresponding premises device.

Each device interface includes a plug-in component.

The bridge server includes a subscriber interface coupled to the event bus, wherein the subscriber interface includes a plurality of agents, wherein each agent is configured to transfer the event data and the control data of a corresponding premises device.

The subscriber interface is configured to exchange the event data and the control data between the event bus and the application server.

Each agent is specific to a protocol of the corresponding premises device.

The system comprises a rules engine configured to control interaction among the plurality of premises devices.

The rules engine includes a rule set configured to control a state change of a first premises device in response to the event data of a second premises device.

At least one of the application server and a premises gateway hosts the rules engine.

The application server hosts a first component of the rules engine, wherein the first component is configured to run a first rule set configured to control a state change of a first premises device in response to the event data of a second premises device.

The premises gateway hosts a second component of the rules engine, wherein the second component is configured to run a second rule set configured to control a state change of a third premises device in response to the event data of a fourth premises device.

The first premises device includes a first data protocol, and the second premises device includes a second data protocol different from the first data protocol.

The third premises device and the fourth premises device include a third data protocol.

The system comprises automation rules running on the rules engine, wherein the automation rules include actions and triggers for controlling interactions between the plurality of premises devices.

The rules engine is configured to treat an event relating to a corresponding premises device as a trigger for at least one rule.

In response to the event the at least one rule triggers at least one action event to at least one of the partner device, at least one other partner device, and at least one of the plurality of devices.

The system comprises a security system installed in the premises, wherein the security system is coupled to the bridge server, wherein the security system includes a plurality of security components.

The user interface is configured to present the event data and state of the security system and receive as input the control data of the security system.

The rules engine is configured to control interaction among the plurality of premises devices and the plurality of security components of the security system.

The rules engine includes a rule set configured to control a state change of a premises device in response to the event data of a security system component.

The rules engine includes a rule set configured to control a state change of the security system in response to the event data of a premises device.

Each virtual device is configured to represent a state change of a corresponding premises device using at least one of control data and the event data of the corresponding premises device.

The system comprises a premises gateway installed in a premises.

The premises gateway comprises a server connection component configured to communicate with at least one server.

The system comprises a gateway server coupled to the application server and the premises gateway, wherein the gateway server is configured to manage gateway components of the premises gateway.

The premises gateway comprises a plurality of communication components configured to communicate with the plurality of premises devices.

The plurality of premises devices is coupled to the gateway.

At least one premises device of the plurality of premises devices are coupled to the gateway.

The premises gateway comprises a device management component configured to manage communications with the plurality of premises devices.

The premises gateway comprises a rules engine configured to control interaction among a set of premises devices of the plurality of premises devices.

Embodiments include a method comprising configuring a bridge server to exchange event data and control data with a plurality of premises devices installed in a premises. The plurality of premises devices includes a plurality of data protocols. The method includes configuring an application server to exchange the event data and the control data with the bridge server. The application server includes a plurality of virtual devices comprising logical models corresponding to the plurality of premises devices and configured to use the event data and the control data to maintain state of the plurality of premises devices. The application server includes a rules engine configured to control interaction among the plurality of premises devices. The method comprises configuring an application engine to communicate with a device application. The device application is configured for execution when installed on a remote device. The device application is configured to present a user interface at the remote device. The user interface is configured to present the event data and state of the plurality of premises devices and receive as input the control data of the plurality of premises devices.

Embodiments include a method comprising: configuring a bridge server to exchange event data and control data with a plurality of premises devices installed in a premises, wherein the plurality of premises devices include a plurality of data protocols; configuring an application server to exchange the event data and the control data with the bridge server, wherein the application server includes a plurality of virtual devices comprising logical models corresponding to the plurality of premises devices and configured to use the event data and the control data to maintain state of the plurality of premises devices, wherein the application server includes a rules engine configured to control interaction among the plurality of premises devices; and configuring an application engine to communicate with a device application, wherein the device application is configured for execution when installed on a remote device, wherein the device application is configured to present a user interface at the remote device, wherein the user interface is configured to present the event data and state of the plurality of premises devices and receive as input the control data of the plurality of premises devices.

The method comprises configuring the bridge server to include an event bus coupled to a plurality of device interfaces, wherein each device interface is configured to transfer the event data and the control data between a corresponding premises device and the event bus.

Each device interface is specific to a protocol of the corresponding premises device.

Each device interface includes a plug-in component.

The method comprises configuring the bridge server to include a subscriber interface coupled to the event bus, wherein the subscriber interface includes a plurality of agents, wherein each agent is configured to transfer the event data and the control data of a corresponding premises device.

The method comprises configuring the subscriber interface to exchange the event data and the control data between the event bus and the application server.

Each agent is specific to a protocol of the corresponding premises device.

The method comprises configuring a rules engine to control interaction among the plurality of premises devices.

The method comprises configuring a rule set of the rules engine to control a state change of a first premises device in response to the event data of a second premises device.

A least one of the application server and a premises gateway hosts the rules engine.

The method comprises configuring the application server to host a first component of the rules engine, wherein the first component is configured to run a first rule set configured to control a state change of a first premises device in response to the event data of a second premises device.

The method comprises configuring the premises gateway to host a second component of the rules engine, wherein the second component is configured to run a second rule set configured to control a state change of a third premises device in response to the event data of a fourth premises device.

The first premises device includes a first data protocol, and the second premises device includes a second data protocol different from the first data protocol.

The third premises device and the fourth premises device include a third data protocol.

The method comprises configuring automation rules running on the rules engine to include actions and triggers for controlling interactions between the plurality of premises devices.

The method comprises configuring the rules engine to treat an event relating to a corresponding premises device as a trigger for at least one rule.

In response to the event the at least one rule triggers at least one action event to at least one of the partner device, at least one other partner device, and at least one of the plurality of devices.

A security system is installed in the premises, wherein the security system is coupled to the bridge server, wherein the security system includes a plurality of security components.

The method comprises configuring the user interface to present the event data and state of the security system and receive as input the control data of the security system.

The method comprises configuring the rules engine to control interaction among the plurality of premises devices and the plurality of security components of the security system.

The rules engine includes a rule set configured to control a state change of a premises device in response to the event data of a security system component.

The rules engine includes a rule set configured to control a state change of the security system in response to the event data of a premises device.

The method comprises configuring each virtual device to represent a state change of a corresponding premises device using at least one of control data and the event data of the corresponding premises device.

A premises gateway is installed in the premises.

The method comprises configuring a server connection component of the premises gateway to communicate with at least one server.

The method comprises configuring a gateway server, coupled to the application server and the premises gateway, to manage gateway components of the premises gateway.

The method comprises configuring a plurality of communication components of the premises gateway to communicate with the plurality of premises devices.

The plurality of premises devices is coupled to the gateway.

A least one premises device of the plurality of premises devices are coupled to the gateway.

The method comprises configuring a device management component of the premises gateway to manage communications with the plurality of premises devices.

The method comprises configuring a rules engine of the premises gateway to control interaction among a set of premises devices of the plurality of premises devices.

As described above, computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The system can be a component of a single system, multiple systems, and/or geographically separate systems. The system can also be a subcomponent or subsystem of a single system, multiple systems, and/or geographically separate systems. The system can be coupled to one or more other components (not shown) of a host system or a system coupled to the host system.

One or more components of the system and/or a corresponding system or application to which the system is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the system herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the systems and methods in light of the above detailed description.

1. A system comprising:
a bridge server configured to exchange event data and control data with a plurality of premises devices installed in a premises, wherein the plurality of premises devices includes a plurality of data protocols;
an application server coupled to the bridge server and configured to exchange the event data and the control data with the bridge server, wherein the application server includes a plurality of virtual devices comprising logical models corresponding to the plurality of premises devices and configured to use the event data and the control data to maintain state of the plurality of premises devices, wherein the application server includes a rules engine configured to control interaction among the plurality of premises devices; and
an application engine coupled to the application server and configured to communicate with a device application, wherein the device application is configured for execution when installed on a remote device, wherein the device application is configured to present a user interface at the remote device, wherein the user interface is configured to present the event data and state of the plurality of premises devices and receive as input the control data of the plurality of premises devices.

2. The system of claim 1, wherein the bridge server includes an event bus coupled to a plurality of device interfaces, wherein each device interface is configured to transfer the event data and the control data between a corresponding premises device and the event bus.

3. The system of claim 2, wherein each device interface is specific to a protocol of the corresponding premises device.

4. The system of claim 3, wherein each device interface includes a plug-in component.

5. The system of claim 2, wherein the bridge server includes a subscriber interface coupled to the event bus, wherein the subscriber interface includes a plurality of agents, wherein each agent is configured to transfer the event data and the control data of a corresponding premises device.

6. The system of claim 5, wherein the subscriber interface is configured to exchange the event data and the control data between the event bus and the application server.

7. The system of claim 5, wherein each agent is specific to a protocol of the corresponding premises device.

8. The system of claim 1, comprising a rules engine configured to control interaction among the plurality of premises devices.

9. The system of claim 8, wherein the rules engine includes a rule set configured to control a state change of a first premises device in response to the event data of a second premises device.

10. The system of claim 8, wherein at least one of the application server and a premises gateway hosts the rules engine.

11. The system of claim 10, wherein the application server hosts a first component of the rules engine, wherein the first component is configured to run a first rule set configured to control a state change of a first premises device in response to the event data of a second premises device.

12. The system of claim 11, wherein the premises gateway hosts a second component of the rules engine, wherein the second component is configured to run a second rule set configured to control a state change of a third premises device in response to the event data of a fourth premises device.

13. The system of claim 12, wherein the first premises device includes a first data protocol, and the second premises device includes a second data protocol different from the first data protocol.

14. The system of claim 11, wherein the third premises device and the fourth premises device include a third data protocol.

15. The system of claim 8, comprising automation rules running on the rules engine, wherein the automation rules include actions and triggers for controlling interactions between the plurality of premises devices.

16. The system of claim 15, wherein the rules engine is configured to treat an event relating to a corresponding premises device as a trigger for at least one rule.

17. The system of claim 16, wherein in response to the event the at least one rule triggers at least one action event to at least one of the partner device, at least one other partner device, and at least one of the plurality of devices.

18. The system of claim 8, comprising a security system installed in the premises, wherein the security system is coupled to the bridge server, wherein the security system includes a plurality of security components.

19. The system of claim 18, wherein the user interface is configured to present the event data and state of the security system and receive as input the control data of the security system.

20. The system of claim 18, wherein the rules engine is configured to control interaction among the plurality of premises devices and the plurality of security components of the security system.

21. The system of claim 20, wherein the rules engine includes a rule set configured to control a state change of a premises device in response to the event data of a security system component.

22. The system of claim 20, wherein the rules engine includes a rule set configured to control a state change of the security system in response to the event data of a premises device.

23. The system of claim 1, wherein each virtual device is configured to represent a state change of a corresponding premises device using at least one of control data and the event data of the corresponding premises device.

24. The system of claim 1, comprising a premises gateway installed in a premises.

25. The system of claim 24, wherein the premises gateway comprises a server connection component configured to communicate with at least one server.

26. The system of claim 25, comprising a gateway server coupled to the application server and the premises gateway, wherein the gateway server is configured to manage gateway components of the premises gateway.

27. The system of claim 24, wherein the premises gateway comprises a plurality of communication components configured to communicate with the plurality of premises devices.

28. The system of claim 27, wherein the plurality of premises devices is coupled to the gateway.

29. The system of claim 27, wherein at least one premises device of the plurality of premises devices are coupled to the gateway.

30. The system of claim 24, wherein the premises gateway comprises a device management component configured to manage communications with the plurality of premises devices.

31. The system of claim 24, wherein the premises gateway comprises a rules engine configured to control interaction among a set of premises devices of the plurality of premises devices.

32. A method comprising:
configuring a bridge server to exchange event data and control data with a plurality of premises devices installed in a premises, wherein the plurality of premises devices includes a plurality of data protocols;
configuring an application server to exchange the event data and the control data with the bridge server, wherein the application server includes a plurality of virtual devices comprising logical models corresponding to the plurality of premises devices and configured to use the event data and the control data to maintain state of the plurality of premises devices, wherein the application server includes a rules engine configured to control interaction among the plurality of premises devices; and
configuring an application engine to communicate with a device application, wherein the device application is configured for execution when installed on a remote device, wherein the device application is configured to present a user interface at the remote device, wherein the user interface is configured to present the event data and state of the plurality of premises devices and receive as input the control data of the plurality of premises devices.

33. The method of claim 32, comprising configuring the bridge server to include an event bus coupled to a plurality of device interfaces, wherein each device interface is configured to transfer the event data and the control data between a corresponding premises device and the event bus.

34. The method of claim 33, wherein each device interface is specific to a protocol of the corresponding premises device.

35. The method of claim 34, wherein each device interface includes a plug-in component.

36. The method of claim 33, comprising configuring the bridge server to include a subscriber interface coupled to the event bus, wherein the subscriber interface includes a plurality of agents, wherein each agent is configured to transfer the event data and the control data of a corresponding premises device.

37. The method of claim 36, comprising configuring the subscriber interface to exchange the event data and the control data between the event bus and the application server.

38. The method of claim 36, wherein each agent is specific to a protocol of the corresponding premises device.

39. The method of claim 32, comprising configuring a rules engine to control interaction among the plurality of premises devices.

40. The method of claim 39, comprising configuring a rule set of the rules engine to control a state change of a first premises device in response to the event data of a second premises device.

41. The method of claim 39, wherein at least one of the application server and a premises gateway hosts the rules engine.

42. The method of claim 41, comprising configuring the application server to host a first component of the rules engine, wherein the first component is configured to run a first rule set configured to control a state change of a first premises device in response to the event data of a second premises device.

43. The method of claim 42, comprising configuring the premises gateway to host a second component of the rules engine, wherein the second component is configured to run a second rule set configured to control a state change of a third premises device in response to the event data of a fourth premises device.

44. The method of claim 43, wherein the first premises device includes a first data protocol, and the second premises device includes a second data protocol different from the first data protocol.

45. The method of claim 42, wherein the third premises device and the fourth premises device include a third data protocol.

46. The method of claim 39, comprising configuring automation rules running on the rules engine to include actions and triggers for controlling interactions between the plurality of premises devices.

47. The method of claim 46, comprising configuring the rules engine to treat an event relating to a corresponding premises device as a trigger for at least one rule.

48. The method of claim 47, wherein in response to the event the at least one rule triggers at least one action event to at least one of the partner device, at least one other partner device, and at least one of the plurality of devices.

49. The method of claim 39, wherein a security system is installed in the premises, wherein the security system is coupled to the bridge server, wherein the security system includes a plurality of security components.

50. The method of claim 49, comprising configuring the user interface to present the event data and state of the security system and receive as input the control data of the security system.

51. The method of claim 49, comprising configuring the rules engine to control interaction among the plurality of premises devices and the plurality of security components of the security system.

52. The method of claim 51, wherein the rules engine includes a rule set configured to control a state change of a premises device in response to the event data of a security system component.

53. The method of claim 51, wherein the rules engine includes a rule set configured to control a state change of the security system in response to the event data of a premises device.

54. The method of claim 32, comprising configuring each virtual device to represent a state change of a corresponding premises device using at least one of control data and the event data of the corresponding premises device.

55. The method of claim 32, wherein a premises gateway is installed in the premises.

56. The method of claim 55, comprising configuring a server connection component of the premises gateway to communicate with at least one server.

57. The method of claim 56, comprising configuring a gateway server, coupled to the application server and the premises gateway, to manage gateway components of the premises gateway.

58. The method of claim 55, comprising configuring a plurality of communication components of the premises gateway to communicate with the plurality of premises devices.

59. The method of claim 58, wherein the plurality of premises devices is coupled to the gateway.

60. The method of claim 58, wherein at least one premises device of the plurality of premises devices are coupled to the gateway.

61. The method of claim 55, comprising configuring a device management component of the premises gateway to manage communications with the plurality of premises devices.

62. The method of claim 55, comprising configuring a rules engine of the premises gateway to control interaction among a set of premises devices of the plurality of premises devices.
